(19) United States
(12) Patent Application Publication
(10) Pub. No.: US 2019/0041277 A1
(43) Pub. Date: Feb. 7, 2019

(54) FORCE SENSING DEVICE

(71) Applicant: HCi Viocare Technologies Ltd., Glasgow (GB)

(72) Inventors: Hariprashanth Elangovan, Glasgow (GB); Christos Kapatos, Cambuslang (GB)

(21) Appl. No.: 16/148,011

(22) Filed: Oct. 1, 2018

Related U.S. Application Data
(62) Division of application No. 15/534,700, filed on Jun. 9, 2017.

(30) Foreign Application Priority Data
Dec. 10, 2014 (GB) 1421950.5
Dec. 10, 2014 (GB) 1421952.1
Dec. 10, 2014 (GB) 1421953.9

(51) Int. Cl. G01L 1/12; A43B 3/00; A43B 1/00; B68C 1/02; A43B 17/18; A47C 31/00; A43B 17/00; A43B 17/02; A47C 7/62

(52) U.S. Cl. CPC G01L 1/122; A43B 3/0005; A43B 1/0054; B68C 1/02; A47C 7/62; A47C 31/00; A43B 17/006; A43B 17/02; A43B 17/18

(57) ABSTRACT

A force or pressure sensing device comprises one or more magnets resiliently held spaced from one or more magnetic sensors such that pressure on the device displaces the magnets relative to the magnetic field sensors. The device may be incorporated into an insole of a shoe, or integrated into a shoe, or integrated into a seat, cushion, mattress or saddle. The device includes one or more magnetic focussing elements on the opposite side of the magnetic field sensor from the magnets to focus and condition the magnetic field passing through the sensor. The magnetic focussing elements may be permanent magnets or magnetic materials having a high magnetic permeability such as mu-metals. Additional magnetic focussing elements may be placed adjacent to the magnets. Plural magnetic field sensors can be arranged in a symmetrical arrangement in a plane below the one or more magnets so that shear forces applied to the device causes lateral relative displacement of the magnet and magnetic field sensors changing the magnetic field sensed by the magnetic field sensors. The device can also include a motion detector such as an accelerometer which may be integral with the magnetic field sensor.

### CROSS-REFERENCES TO RELATED APPLICATIONS

This application is a divisional of U.S. patent application Ser. No. 15/534,700, filed Jun. 9, 2017, pending, which is the U.S. national phase of International Patent Application No. PCT/GB2015/053785, filed Dec. 10, 2015 which designated the U.S. and claims priority to Great Britain Patent Application No. 1421950.5, filed Dec. 10, 2014, Great Britain Patent Application No. 1421952.1, filed Dec. 10, 2014, Great Britain Patent Application No. 1421953.9, filed Dec. 10, 2014, the entire contents of each of which are hereby incorporated by reference in this application.

### STATEMENT REGARDING FEDERALLY SPONSORED RESEARCH OR DEVELOPMENT

(NOT APPLICABLE)

### BACKGROUND

The present invention relates to a force sensing device.

The need to measure force arises in many applications. Further, there are a great variety of different technologies for providing force sensing. The present invention is particularly concerned with force sensing devices which are suitable for use as non-invasive medical/sports/fitness sensors which can be used to measure the forces exerted on or by a human body. By measuring force, pressure, torque and shear may be calculated. The aim is to provide sensing devices which can be used in wearable devices such as shoes, smart garments, and also objects where force exerted on or by the human body is of interest such as mattresses, seats, wheelchairs, saddles, skis and other sporting equipment etc.. The measurements of force in these situations can be invaluable for use in physical rehabilitation, sports training or in achieving medical remedial objectives such as avoiding pressure sores or pressure points. As an example, the accurate measurement of foot-ground pressure data gives important information about a person's foot condition and gait and can be used to improve recovery, performance or to design orthotics footwear. In the case of mattresses, seats and saddles such as wheelchair cushions, bed mattresses, automobile seats and horse or bicycle saddles, the detection and recording of pressure can be important for both skin health and performance reasons. Excess skin pressure can cause soft tissue breakage and ulceration.

Foot problems are also one of the many complications that are associated with diabetes. Problems such as calluses, ulcers, loss of feeling (neuropathy) and poor circulation can lead to infection, peripheral vascular disease and ulceration, which can result in the need for amputation. Because of diabetic peripheral neuropathy, it may be that the patient is unaware of pressure points on their feet and in the absence of careful daily observation, serious foot problems can result. The provision of foot-ground pressure monitoring can provide not only a warning of such problems, but can also allow accurate study of the walking pattern of a patient, allowing the design of customised assistive devices such as orthoses and shoe supports.

In the sports and fitness domain, wearable devices, in particular those which can interface with a smartphone, have become very popular and the provision of a pressure or force sensing device which can be used to monitor pressure at the foot, knees and buttocks can provide continuous real-time monitoring of these areas which can be important to athletes such as runners, golfers, skiers and cyclists. Such devices are also important, and yield invaluable quantitative data, for the hillwalking fraternity.

Currently three main technologies are used for commercial in-shoe pressure measuring systems. For example, the F scan system by Tekscan is based on a resistive sensor. This consists of a force-sensing resistor made from a conductive foam held between two electrodes and as pressure is applied to the sensor the conductive foam is distorted and the resistance changes. Capacitance technology such as that used in the Pedar system by Novel is based on a sensor consisting of two conductive electrically charged plates separated by a dielectric elastic layer. When pressure is applied to the sensor the dielectric elastic layer bends, shortening the distance between the two plates and changing the capacitance. Piezoelectric strain gauges have also been proposed, such as the Surrosense shoe insole (by Orpyx). This sensor uses a piezoresistive semiconductor material whose bulk resistivity changes as pressure is applied.

U.S. Pat. No. 5,325,869 discloses a magnetically-based sensor for use as a shoe insert. The sensor includes at least one magnet and at least one Hall-effect transducer fixed to opposite sides of a deformable pad. Force exerted on the sensor deforms the pad changing the distance between the magnet or magnets and one or more sensors. A plurality of such sensors may be incorporated into an insole of a shoe.

### BRIEF SUMMARY

For the range of applications described above, as well as requiring the sensors to provide accurate and repeatable force or pressure measurements, the sensors must be durable and reliable and preferably have a low power consumption. It is also desirable if the accuracy of the sensors is not affected by forces being applied from different directions or, in the case of magnetic sensors, by external magnetic influences such as the earth's magnetic field or the proximity of metal or other magnetic objects.

Accordingly, the present invention provides a force sensing device comprising: a magnetic field generator, a magnetic field sensor, a resilient support supporting the magnetic field generator and magnetic field sensor for relative movement in response to force applied to the sensor, the magnetic field sensor being disposed to measure changes in the magnetic field from the magnetic field generator resulting from such relative movement, the device further comprising a magnetic focussing element disposed on an opposite side of the magnetic field sensor from the magnetic field generator to focus the magnetic field from the magnetic field generator through the magnetic field sensor.

The device of the invention effectively measures the displacement of the magnetic field generator relative to the magnetic field sensor. As this displacement is against the resistance provided by the resilient support, this displacement corresponds to a force that can be calculated or measured (in a calibration process). Displacements in the three orthogonal directions correspond to compression, expansion and shear. Knowing the force and the area over which it is applied gives a pressure measurement. Some embodiments described below use a miniature force plate to provide tilt and torque measurements.

The use of the magnetic focussing element causes an increased amount of flux from the magnetic field generator to pass through the magnetic field sensor. This improves the sensitivity of the sensor increasing the resolution of the sensor output and the dynamic range of the device. It also reduces the sensitivity of the device to tilt of the magnetic field generator, for example caused by uneven application of a force on the surface of the device. Because the magnetic flux through the sensor is stronger, no amplification of the output signals is required which reduces the power consumption of the device.

The focussing element can be a permanent magnet, a magnetized element, an electromagnet, or can be made from a material with a high magnetic permeability such as a meta-material or a mu-metal (nickel-iron alloy).

The magnetic field sensor can be a Reed sensor, Hall-effect sensor, magnetic tunnelling junction (MTJ) sensor, anisotropic magnetoresistance (AMR) sensor, differential magnetoresistance (DMR) sensor, giant magnetoresistance sensor (GMR) or a Lorentz force sensor.

A plurality of magnetic field sensors and a plurality of magnetic focussing elements may be provided, each disposed respectively on an opposite side of the magnetic field sensors from the magnetic field generator, the magnetic field sensors being disposed to measure changes in the magnetic field from the magnetic field generator resulting from relative movement between the magnetic field generator and magnetic field sensors towards and away from each other and laterally relative to each other, whereby the device can measure shear forces applied to the device.

A magnetic focussing element may be disposed adjacent to each of the plurality of magnetic field sensors. There may be two, three or four magnetic field sensors and the magnetic field sensors may be symmetrically disposed with respect to the magnetic field generator. The magnetic field sensors may be arranged with one in the centre of an arrangement and the remainder disposed around it, and the magnetic field sensor in the centre of the arrangement may be positioned on the central axis of the magnetic field from said magnetic field generator. A further magnetic field generator may be positioned on the central axis of the magnetic field from said magnetic field generator. Optionally a further magnetic focussing element may be positioned on the central axis of the magnetic field from said magnetic field generator.

In one embodiment there may be at least four magnetic field sensors arranged at the vertices of a rectangular arrangement, e.g. a square, defining a plane from which the magnetic field generator is spaced. This allows in-plane orthogonal (x and y) displacements to be calculated by subtracting the readings from opposite magnetic field sensors. It also allows out-of-plane (z direction) displacement to be obtained by summing all four readings. This reduces the signal processing burden.

Another aspect of the invention provides a force sensing device comprising a magnetic field generator, a magnetic field sensor, a resilient support supporting the magnetic field generator and magnetic field sensor for relative movement in response to force applied to the device, the magnetic field sensor being disposed to measure changes in the magnetic field from the magnetic field generator resulting from such relative movement, the magnetic field sensor being a magnetoresistance sensor operative to sense relative movements of the magnetic field generator and magnetic field sensor in two orthogonal directions whereby the force sensing device senses both compressive and shear force applied to the force sensing device.

Thus this aspect of the invention uses a magnetoresistance sensor to sense changes in the magnetic field caused by relative relative movements of the magnetic field generator and magnetic field sensor in two orthogonal directions allowing the device to sense and measure shear forces applied to it, as well as compressive forces. Shear forces will displace the magnetic field generator laterally relative to the magnetic field sensor, whereas compressive (or extension) forces displace it towards and away from the sensor. The inventors have found that a single magnetoresitance sensor can sense and measure these shear forces without requiring plural magnetic field sensors to triangulate the relative motion.

The magnetoresistance sensor may be an anisotropic magnetoresistance (AMR) sensor, differential magnetoresistance (DMR) sensor or giant magnetoresistance sensor (GMR). A magnetic focussing element can be used with this aspect of the invention too.

The resilient support may comprise a first layer which is resilient and supports the magnetic field generator and a second resilient layer between the magnetic field generator and the magnetic field sensor. The first layer may be a material such as poron, foam, EVA, silicone, silicone gel or urethane and it may comprise a combination of flexible and rigid materials. The second layer is preferably a flexible and bendable material which preferably exhibits linear compression characteristics and is preferably an electrical insulator, such as poron, foam, EVA, silicone gel or urethane. The second layer may comprise an air cushion.

Preferably the magnetic field sensor and magnetic focussing element are mounted in the second resilient layer.

The device may also comprise a third layer provided on the opposite side of the second layer from the first layer. The third layer may be made of a flexible and bendable material such as poron, foam, EVA, silicone, silicone gel and urethane and it acts as a protective layer for the magnetic field sensor and magnetic focussing element.

The device may further comprise a second magnetic focussing element disposed adjacent to the magnetic field generator, preferably between the magnetic field generator and the magnetic field sensor.

Another aspect of the invention provides a force sensing device comprising a magnetic field generator, at least four magnetic field sensors, a resilient support supporting the magnetic field generator and magnetic field sensors for relative movement in response to force applied to the device, the magnetic field sensors being disposed to measure changes in the magnetic field from the magnetic field generator resulting from such relative movement, the at least four magnetic field sensors being arranged at the vertices of a rectangular arrangement defining said plane from which the magnetic field generator is spaced by the resilient support.

The magnetic field sensors may be symmetrically disposed with respect to the magnetic field generator. This placement of the sensors goes beyond triangulation which significantly increases the accuracy and resolution of shear detection, enabling this arrangement to detect micro-shear, as well as increasing the accuracy and resolution of force monitoring, eliminating possible artefacts and inaccuracies in detecting pressure which can result from lateral displacement (due to shear). It also eliminates the need for complicated mathematical modelling if only pressure is to be measured, as in this version; the sensor which is directly under the magnetic field generator is capable of measuring pressure without the need of the surrounding sensors. Also, by activating only the central sensor, or by not taking the data of the surrounding sensors into account, the arrangement can be made to read pressure only, very accurately and at the same time be very energy efficient.

In one embodiment a second magnetic field generator may be positioned on the central axis of the magnetic field from the first magnetic field generator, preferably in or adjacent to the plane of the magnetic field sensors. Preferably a magnetic focusing element is provided for each of the plurality of magnetic field sensors, each focussing element being disposed adjacent to its respective magnetic field sensor. A further magnetic focussing element may be positioned on the central axis of the magnetic field from the magnetic field generator.

In one embodiment four magnetic field sensors are provided arranged at the vertices of a rectangular arrangement, three or four of which define said plane from which the magnetic field generator is spaced by the resilient support. The placement of the sensors this rectangular or “cross configuration”, especially when an additional magnetic field generator is provided in the centre of the arrangement, is designed to measure long “sliding”—long displacement which can lead to continuous or semi-continuous shear readings. It can cover big areas and it is ideal for mattresses and cushions. A second magnetic field generator is provided in the centre of the arrangement acts as self-zeroing and self-calibration for the arrangement, as well as self-alignment of the top magnetic field generator. This configuration can detect shear over a big area, something that a conventional sensor configuration cannot do. So instead of using two, three or four “triangular” configurations, the user can use only one “cross” configuration.

In another embodiment the plurality of magnetic field sensors may be arranged in an array, for example a circular array symmetrically around the axis of the field generated by the magnetic field generator and in plane below it. The advantage of this configuration is accuracy and resolution in all 3 dimensions, which is unparalelled in any prior art sensor configuration. Even the slightest movement can be detected accurately and thus every shear or pressure applied will be recorded. This is a configuration for high precision.

Optionally a plurality of magnetic field generators are provided, one for each of said magnetic field sensors, each of the plurality of magnetic field generators being disposed in a corresponding position relative to the respective one of said magnetic field sensors, the plurality of magnetic field generators being mechanically linked together. This mechanically unifies the magnetic field generators allowing the device to detect tilt of the unified magnetic field generators. The magnetic field generators may be mechanically linked together by elongate linking elements or by the plurality of magnetic field generators being attached to a planar carrier element such as a disc. The linking element(s) is preferably rigid—e.g. of a rigid non-magnetic material such as plastic.

The device of the invention may further comprise a motion sensor for measuring motion of the device. The motion sensor may comprise at least one of: a piezoelectric sensor, a gyroscopic sensor, a 2-axis accelerometer, a 3-axis accelerometer. The device may further comprise an orientation sensor for sensing the orientation of the device, the orientation sensor comprising at least one of: a piezoelectric sensor, a gyroscopic sensor, a 2-axis accelerometer, a 3-axis accelerometer. The motion sensor and orientation sensor may be integrated with each other. The motion sensor may be integrated with the magnetic field sensor.

The provision of the motion sensor in the force sensing device provides for improved assessment of motion in medical, sports and fitness applications by allowing the forces and associated movements to be detected. Thus a better analysis of the motion of the individual being monitored is provided. Further this is achieved by one device—obviating the need to monitor motion separately from forces (e.g by use of video recording and visual markers to record motion and pressure plates to record forces) which involves the difficult task of synchronising the measurements. With the invention it is also easy to use a plurality of force sensing devices together to give a more complete picture of the forces and movement.

One or more devices of the invention, optionally in this case without the magnetic focussing element but otherwise as above, can be incorporated into a shoe insole or into a shoe or into another object where pressure is to be measured such as a seat, mattress, saddle or cushion. Where the insole, shoe or object is itself formed from several layers, the device preferably utilises these layers for its own structure so that one or more of these layers may constitute the resilient support. For example, a shoe insole typically has an upper layer closer to the foot and a lower layer closer to the sole of the shoe. The magnetic field generator may be disposed in or adjacent to an upper layer of the insole and the magnetic field sensor (and focussing element where provided) disposed in or adjacent to a lower layer of the insole. Such an insole can comprise other layers, such as a resilient mid-layer between the upper and lower layers, and may also have upper and lower cover or protective layers.

In an alternative embodiment the device of the invention, optionally in this case without the magnetic focussing element but otherwise as above, is incorporated into the structure of a shoe with, for example, the magnetic field generator disposed in an insole of the shoe and the magnetic field sensor (and focussing element where provided) disposed in the sole of the shoe over which the insole is disposed in use. Such an insole can be removable and disposable. Thus it may not be affixed to the sole of the shoe. The bottom surface of such an insole and the top surface of the sole of the shoe can comprise male and female surface features which inter-engage to prevent sliding of the insole over the sole of the shoe when in use.

Similarly, seats, such as wheelchair seats or vehicle seats, mattresses, saddles and cushions typically are formed by combining several layers of different materials. There may be outer covering layers to provide protection and resilient inner layers to provide support and cushioning. The device of the invention, optionally in this case without the magnetic focussing element but otherwise as above, may be incorporated into such a structure utilizing one of the resilient inner layers as the resilient support to support the magnetic field generator for movement relative to the magnetic field sensor and magnetic focussing element.

One or more devices of the invention can be incorporated into orthoses, and prostheses, to monitor their use. They can give information about the usage which is useful for checking compliance and proper usage, and for training the user to use them effectively. They also allow lifetime monitoring for giving indications of wear and correct function. Thus this aspect of the invention provides an instrumented orthotic or prosthetic including one or more force sensors in accordance with the different aspects of the invention mentioned herein.

Thus a first of these aspects of the invention provides a shoe comprising a force sensing device comprising a magnetic field generator, a magnetic field sensor, a resilient support supporting the magnetic field generator and magnetic field sensor for relative movement in response to force applied to the device, the magnetic field sensor being disposed to measure changes in the magnetic field from the magnetic field generator resulting from such relative movement, wherein the magnetic field generator is disposed in an insole of the shoe and the magnetic field sensor is disposed in a sole of the shoe over which the insole is disposed, and wherein said resilient support comprises at least one of said insole and sole.

A second of these aspects of the invention provides a seat, mattress, saddle or cushion incorporating a force sensing device comprising a magnetic field generator, a magnetic field sensor, a resilient support supporting the magnetic field generator and magnetic field sensor for relative movement in response to force applied to the device, the magnetic field sensor being disposed to measure changes in the magnetic field from the magnetic field generator resulting from such relative movement, wherein the magnetic field generator of the device is disposed in a first layer and the magnetic field sensor is disposed in a second layer of the seat, mattress, saddle or cushion. the resilient support may comprise at least one of said first layer, said second layer, and/or an intermediate layer between said first layer and said second layer.

The force sensing device in these two aspects of the invention may have the further features mentioned above such as plural sensors and focussing elements or a motion and/or orientation sensor.

Any of the force sensing devices above may include a top plate to which the magnetic field generator is attached, the top plate providing a planar surface and allowing the sensing device to act as a miniature force plate, measuring force in the three orthogonal directions, as well as rotation around those axes. The top plate may be rigid or semi-rigid. More than one force sensing device may be associated with each top plate. The top plate may be the upper planar surface of a molded plastics plug incorporating the magnetic field generator, the plug being configured to fit into a correspondingly-shaped cavity in a resilient layer (e.g. insole, pad or layer of a mattress, seat or saddle). The magnetic field sensors and associated ancillary devices (e.g. power supply, controller and communications) may be provided in the resilient layer, interconnected by a flexible pcb for example, preferably molded into the resilient layer. Apart from the provision of the top plate, the MFPs otherwise share the features and components of the other embodiments.

Preferably the device of the invention includes its own local power supply, such as a battery. The device may also include a local control module such as a microprocessor for controlling the device and providing an output. Preferably the device includes a wireless communication unit, such as Wi-Fi or Bluetooth, so that the measurements can be transmitted to a remote module for recording and displaying the measurements, such as a software application running on a personal computer, tablet computer, or smartphone.

As well as communicating with a remote module, the device of the invention may be provided with network connectivity so that it can wirelessly communicate with other devices of the invention to exchange data and to exchange control signals. For example, the data acquisition rate of each device may be changed based on signals from a central module or from other devices.

The device of the invention may be controlled to continuously measure applied forces and output its measurements. Preferably, though, the device is only activated periodically, with a frequency (data acquisition rate) which depends on the application, in order to reduce power consumption. Thus, for example, in measuring foot pressure during walking, making pressure measurements at a frequency of 3 Hz (three measurements per second) may be sufficient. For measuring running, or other more active applications, a higher sampling frequency may be required and for slow walking or other less energetic applications, a lower sampling frequency may be required. The sampling frequency may be automatically adaptive based on the gait frequency so as to increase with a faster gait and decrease with a slower gait.

In general the average human gait cycle lasts for 1.4 seconds of which 54% is stance phase and 46% swing phase. For one leg, loading occurs for 0.68 seconds, unloading for 0.008 seconds and zero load for 0.64 seconds. If accurate measurements during the loading phase are required, therefore, for example by taking 10 measurements per loading phase, the data acquisition frequency would be about 10/0.68=14.7 Hz. In practice, data acquisition rates from 3 to 150 Hz are used, more preferably 5 to 50 Hz, yet more preferably 10 to 20 Hz.

In a mattress, seat or saddle application, lower data acquisition rates may be used for monitoring sitting or lying, but in a vehicle seat crash test, for example, a high data acquisition rate may be required. Again the data acquisition rate may be automatically adaptive based on the frequency of the activity sensed so as to increase with a faster activity and decrease with a slower activity.

In one embodiment one device in a set of devices may be used to measure a characteristic frequency of the activity (for example the number of steps per minute) and the microcontrollers local to the devices, or the central module, can control other devices in the network to adjust their sampling frequency appropriately based on the measured characteristic frequency of the activity. Alternatively the signal from one device can be used as a trigger to activate other devices to turn on and measure pressure (for example a device positioned under a heel can detect the heel strike in a stride and turn on other devices in a network).

The invention can therefore provide a force sensing device which is useful in the medical, health and sports and fitness domains. For example it provides the ability to monitor forces, and optionally joint angles and movements, at the foot, knees and buttock areas in real time and this is of use in the sports and fitness domains for athletes, outdoor enthusiasts including hillwalkers, golfers, skiers and cyclists in improving technique, monitoring performance and avoiding injury and fatigue. The ability to provide all three force, joint angles and movement information means that posture and limb positioning and motion can be monitored. The same devices can be used to measure forces and motion in the feet and legs, for example, as well as motion of the upper body and arms, which can be invaluable in a variety of sports.

### BRIEF DESCRIPTION OF THE DRAWINGS

The invention will be further described by way of examples with reference to the accompanying drawings in which:

FIG. 1 schematically illustrates a cross-section through a device according to a first embodiment of the invention;

FIG. 2 illustrates in schematic plan view the arrangement of the device of FIG. 1;

FIG. 3A illustrates the focussing effect of a magnetic focussing element and FIG. 3B illustrates the magnetic field without such a magnetic focussing element;

FIGS. 4A and 4B illustrate respectively the effects of tilting the magnetic field generator in an embodiment of the invention including a magnetic focussing element;

FIGS. 5A and B illustrate the effects of tilting the magnetic field generator without a magnetic focussing element;

FIGS. 6A and 6B respectively illustrate schematic side and plan arrangements of a device according to a second embodiment of the invention;

FIGS. 7A and 7B respectively illustrate schematic side and plan cross-sectional views of a sensor according to a third embodiment of the invention;

FIGS. 8A and 8B illustrate schematic side and plan arrangements of a fourth embodiment of the invention;

FIGS. 9A and 9B illustrate schematic side and plan arrangements of a fifth embodiment of the invention;

FIG. 10 schematically illustrates a cross-sectional view through an insole incorporating a device in accordance with a twenty third embodiment of the invention;

FIG. 11 schematically illustrates a cross-sectional view a shoe incorporating a device in accordance with a twenty fourth embodiment of the invention;

FIG. 12 schematically illustrates a cross-sectional view of a twenty sixth embodiment of the invention in which a device is incorporated into a laminar structure for a cushion, seat, mattress or saddle;

FIGS. 13A-C illustrate placement of devices according to an embodiment of the invention to monitor foot pressure;

FIGS. 14A-C illustrate a further device placement for foot pressure monitoring;

FIGS. 15A-C illustrate a further device placement for foot pressure monitoring;

FIGS. 16A-C a further device placement for foot pressure monitoring;

FIG. 17 is a schematic block diagram of the electronic components of an embodiment of the invention;

FIG. 17A schematically illustrates the arrangement of an antenna in one embodiment of the invention;

FIGS. 18A to C illustrate bi-directional devices according to a further embodiment of the invention;

FIG. 19 schematically illustrates a cross-section through a force sensing device according to a sixth embodiment of the invention;

FIG. 20 illustrates in schematic plan view the arrangement of the sensor of FIG. 19;

FIGS. 21A and B illustrate respectively the effects of tilting the magnetic field generator in an embodiment of the invention including magnetic focussing elements;

FIGS. 22A and B illustrate the effects of tilting the magnetic field generator without a magnetic focussing element;

FIGS. 23A and B respectively illustrate schematic side and plan arrangements of a device according to a seventh embodiment of the invention;

FIG. 23C is a schematic isometric view of the main components of the embodiment of FIGS. 5A and B;

FIGS. 24A, B and C illustrate schematic side and plan arrangements of an eighth embodiment of the invention;

FIGS. 25A and B illustrate schematic side and plan arrangements of a ninth embodiment of the invention;

FIGS. 26A and B illustrate schematic side and plan arrangements of a tenth embodiment of the invention;

FIGS. 27A and 27B illustrate schematic side and plan arrangements of an eleventh embodiment of the invention;

FIGS. 28A to C illustrate bi-directional force sensing devices according to a further embodiment of the invention;

FIG. 29 schematically illustrates three magnetic field generators linked in a frame for use in another embodiment of the invention;

FIGS. 30A and B schematically illustrate the three linked magnetic field generators of FIG. 29 in a sensor;

FIGS. 31A and B schematically illustrate four linked magnetic field generators of in a sensor according to another embodiment of the invention.

FIG. 32 schematically illustrates a cross-section through a sensor according to a twelfth embodiment of the invention;

FIG. 33 illustrates in schematic plan view the arrangement of the sensor of FIG. 32;

FIGS. 34A and B respectively illustrate schematic side and plan arrangements of a sensor according to a thirteenth embodiment of the invention;

FIGS. 35A and B respectively illustrate schematic side and plan cross-sectional views of a sensor according to a fourteenth embodiment of the invention;

FIGS. 36A and B illustrate schematic side and plan arrangements of a fifteenth embodiment of the invention;

FIGS. 37A and B illustrate schematic side and plan arrangements of a sixteenth embodiment of the invention;

FIGS. 38 and 39 illustrate schematic side and plan arrangements of a seventeenth embodiment of the invention;

FIGS. 40A, B and C illustrate schematic side, plan and isometric arrangements of an eighteenth embodiment of the invention;

FIGS. 41A and B illustrate schematic side and plan arrangements of a nineteenth embodiment of the invention;

FIGS. 42A and B illustrate schematic side and plan arrangements of a twentieth embodiment of the invention;

FIGS. 43A and B illustrate schematic side and plan arrangements of a twenty first embodiment of the invention;

FIGS. 44A and B illustrate schematic side and plan arrangements of a twenty second embodiment of the invention;

FIG. 45 shows molding of devices in accordance with a further embodiment of the invention into a shoe insole;

FIG. 46 shows a printed circuit board and top plates with magnets in the construction of the insole of FIG. 45;

FIG. 47 shows a top layer of an insole with top plates and magnets;

FIG. 48 is a schematic cross-section of the insole of FIGS. 45 to 47;

FIG. 49 is a schematic top view of an alternative insole in accordance with another embodiment of the invention;

FIG. 50 is a schematic cross-section of an alternative insole in accordance with another embodiment of the invention;

FIG. 51 is a schematic top view of an alternative insole in accordance with the embodiment of FIG. 50.

### DETAILED DESCRIPTION

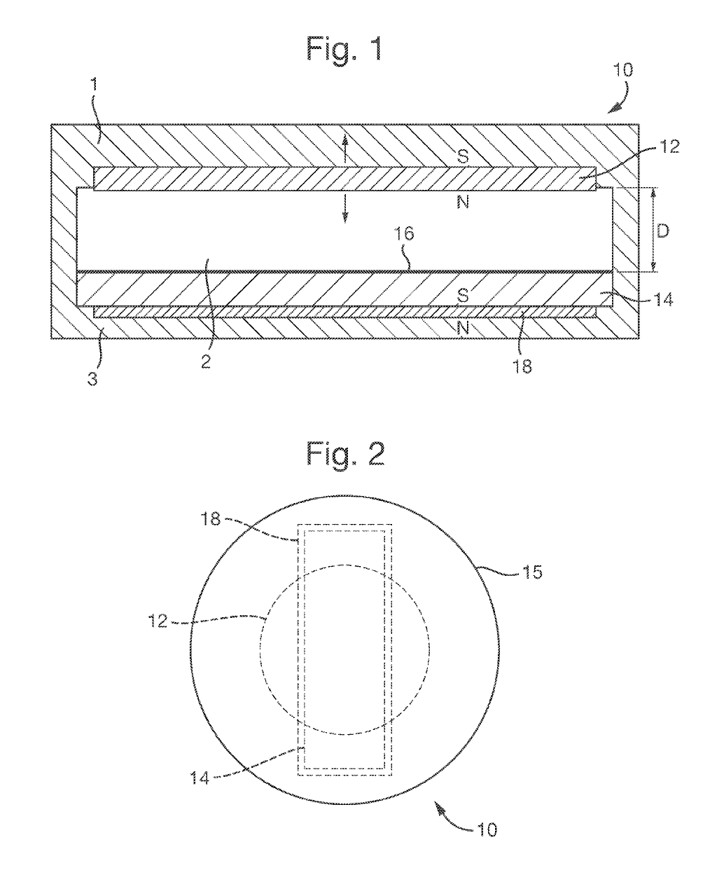

FIGS. 1 and 2 schematically illustrate a pressure or force sensing device in accordance with a first embodiment of the invention. The device comprises a magnetic field generator 12 which in this embodiment is a circular disk permanent magnet, e.g. a ferromagnetic material magnet such as magnetite (Fe3O4) or Neodymium, which is spaced a distance D above a magnetic field sensor 14 which in this embodiment is a Hall-effect sensor such as a Honeywell SS466A or a Honeywell SS30AT, though other types of magnetic field sensor can be used. A variety of MEMS magnetometers are available. The spacing D is provided by mounting the magnetic field generator 12 in a layer 1 made of flexible and bendable material such as poron, foam, EVA, silicone, silicone gel or urethane and providing a second layer 2 between the magnetic field generator 12 and magnetic field sensor 14. The layer 2 is a flexible and bendable material such as poron, foam, EVA, silicone, silicone gel and urethane, or can be or contain a sealed air-filled cushion. The layers 1 and 2 act together as a resilient support which allow relative movement of the magnetic field generator 12 and magnetic field sensor 14 by changing the spacing D. The layer 1 may be provided with rigid parts, e.g. sides or top, made from metal or plastic which form a device casing 15. A protective film 16 of PVC or high density foam or hard silicon can be provided between the second layer 2 and the magnetic field sensor 14.

On the opposite side of the magnetic field sensor 14 from the magnetic field generator 12 is provided a magnetic focussing element 18. This can be a permanent magnet or magnetized element or electromagnet, or alternatively a high magnetic permeability material such as a metal alloy such as mu-metal or alloy containing nickel and iron, or pure iron. The focussing element also acts as shielding to protect the sensor from external interference.

The structure of the focussing (and shielding) layer preferably depends on the shape of the sensor and the application that is meant to be used in. Large single sheet focussing (and shielding) layers common to multiple force sensing devices are avoided, as they tend to be easily damaged, make the setup heavy and in some cases introduce cross-talk in the sensor system. In the majority of cases the focussing (and shielding) layer is divided to small individual “islands” located under the sensor or sensors 14, e.g. one per force sensing device 10. This is the case, for example, when the device is to be used in a mattress: each one of the devices in the mattress has its one focussing (and shielding) layer. In contrast, some (not all, depending on the number of sensors and application) of the insoles that incorporate the sensors of the invention have focussing (and shielding) layers that act for a group of sensors: specific areas, such as the metatarsal or the heel, so the sensors located at these areas, have a common, single, S&F layer.

The magnetic focussing element 18 is oriented with its magnetic poles in the same orientation as the magnetic field generator 12. Thus as illustrated in FIG. 1 in both cases the south pole is uppermost and north pole lowermost.

The bottom of the device 10 is covered with a third layer 3, again made of a flexible and bendable material such as poron, foam, EVA, silicone, silicone gel or urethane which acts as a protective layer for the magnetic field sensor 14. The layer 3 can be omitted in an alternative embodiment or can be made of a rigid material such as metal or plastic if the device as whole does not need to be bendable.

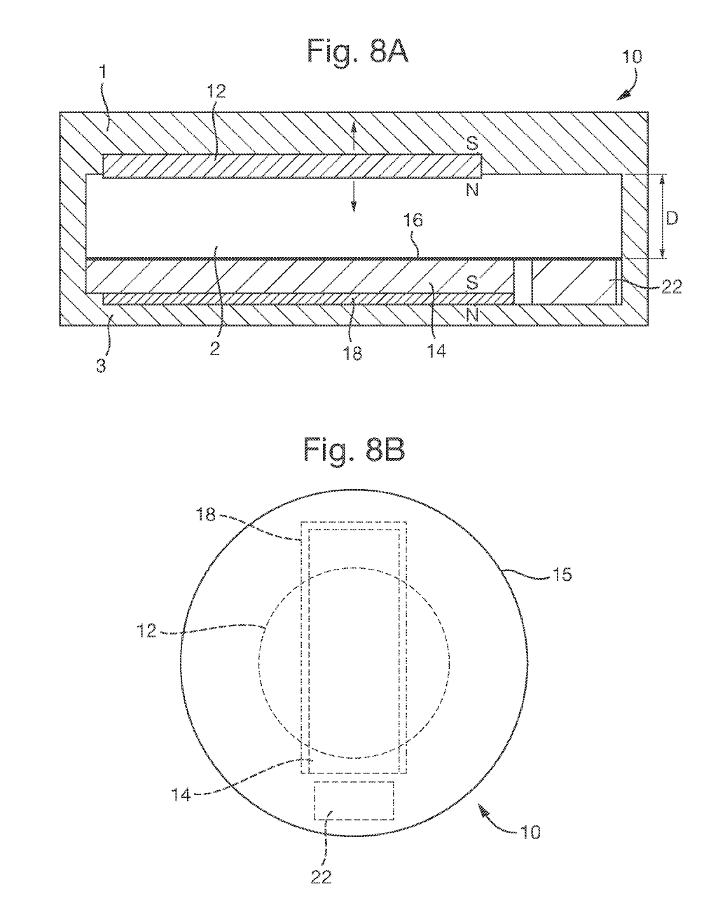

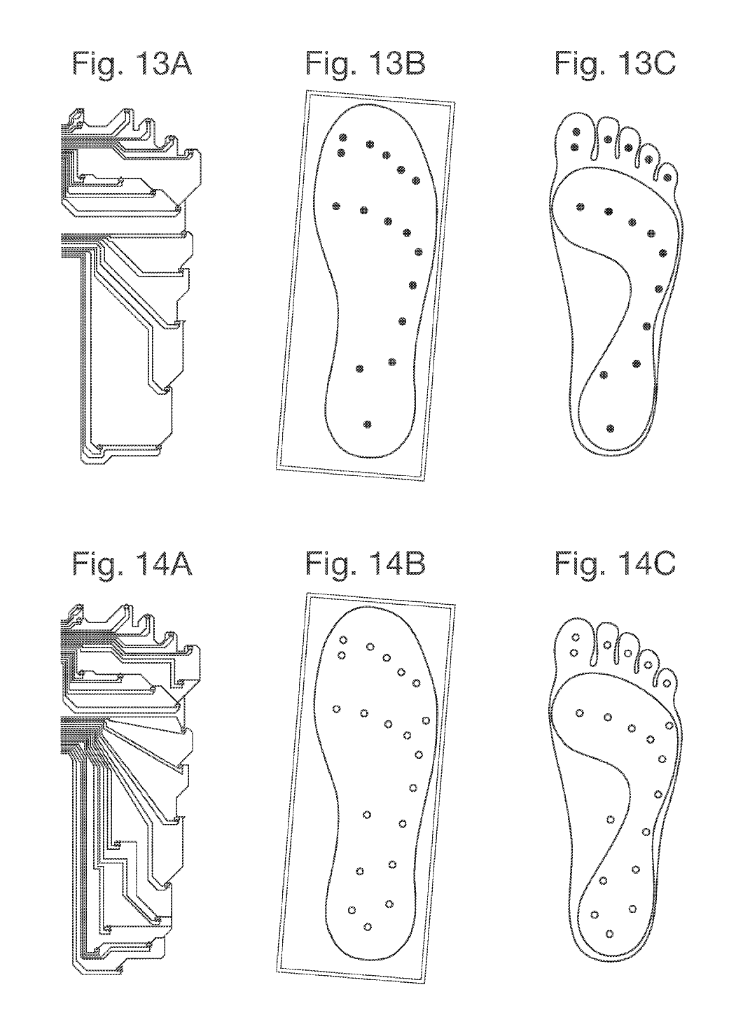

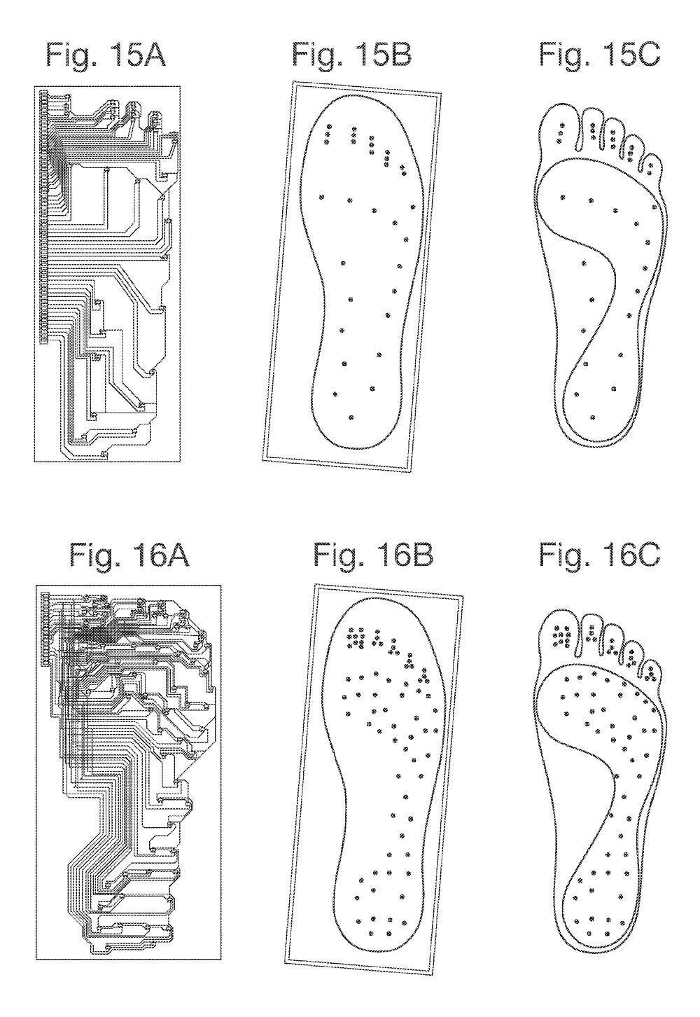

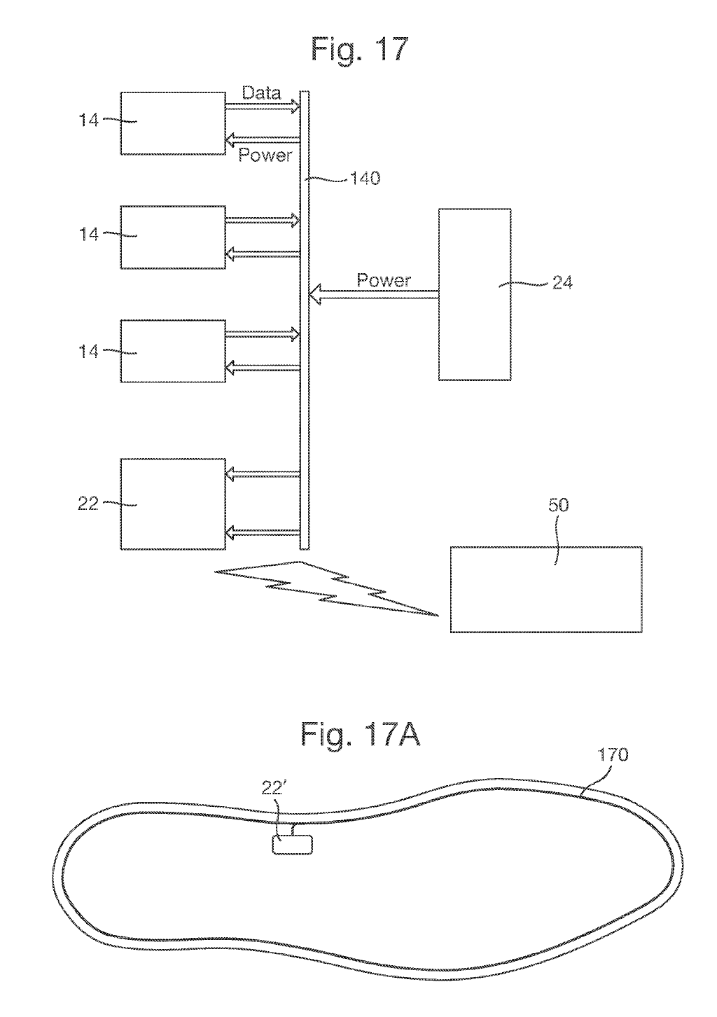

Although not illustrated in FIG. 1, as shown in FIGS. 8A, B and 9A, B, the layer 2 may also accommodate electronic instrumentation for running the device 10. It therefore may contain a power supply unit 24, comprising a battery, for example a rechargeable battery, and a programmable microcontroller and wireless communication unit 22 for controlling the magnetic field sensor and processing the pressure measurements and transmitting them to a remote device 50 (see FIG. 17). The power supply unit 24, magnetic field sensor 14, microcontroller and wireless communication unit 22 are interconnected by means of a printed circuit board 140 (see FIGS. 13 to 17) or flexible printed circuit board 140, though they can be connected by wires. Preferably the microcontroller and wireless communication unit 22 are incorporated into a single unit (chip) to save space and power. Although the battery is described as a rechargeable battery, it can be a replaceable battery or a self-charging mechanism which charges in response to distortion of the pressure sensor (for example a piezoelectric charging mechanism).

In operation the magnetic field sensor 14 is powered by the power supply unit 22 and senses and records changes in the magnitude of the magnetic field from the magnetic field generator 12 caused by relative movement of the magnetic field generator 12 and magnetic field sensor 14 in response to force and pressure changes applied to the pressure sensor 10. Such force or pressure causes the layers 1 and 2 to deform resulting in relative vertical displacement of the magnetic field generator 12 and magnetic sensor element 14 changing the distance D. The changes in magnetic field sensed by the magnetic field sensor 14 are translated into voltage changes which are recorded by the programmable microcontroller unit and converted into force and pressure readings by means of an on-board calibration which correlates voltage changes with corresponding load values. Such calibration can be achieved in an initial calibration process in which known forces are applied to the device 10 while recording the voltage output from the magnetic field sensor 14. In the medical field, or where high accuracy is required, each device 10 can be individually calibrated and the calibration results stored in the programmable microcontroller or the remote module 50. In health and fitness applications, where lower accuracy is acceptable, but lower cost important, only samples of batches need to be calibrated and the results stored for all devices of the batch.

The processed or unprocessed force and/or pressure readings are then output wirelessly to a remote data recording, analysis and display module 50 (see FIG. 17) such as a software application running on a personal computer, tablet computer or smartphone. The readings may be passed raw to the wireless communication unit 22 to be processed at the remote module 50. The readings may be compressed for transmission. Further, some processing, such as conversion by way of calibration data may be conducted by the microprocessor 22.

As well as communicating with the remote module 50, the device 10 can be provided with network connectivity so that it can wirelessly communicate with other devices 10 to exchange data and to exchange control signals. For example, the data acquisition rate of each device 10 may be changed based on signals from the central module 50 or from other devices 10.

In order to transmit the data wirelessly an antenna is required for the communication with the remote module 50. FIG. 17A schematically illustrates the arrangement of an antenna 170 as a loop antenna, which can be thought of as a folded dipole antenna. Its position is subject to the shape and application of the medium the sensors are placed within. For example for the majority of insoles, the antenna 170 follows the outline of the entire insole as illustrated. In some insoles however, where low acquisition and transmission rates are used, the antenna can be located only in the arch area of the insole. When located only in the arch area, the antenna may be arranged in a spiral shape. The antenna 170 is made of thin wire and it is connected with the wireless transmitter 22′ of the sensor system (Bluetooth, Wi-Fi, etc.). As an alternative a PCB antenna can be used.

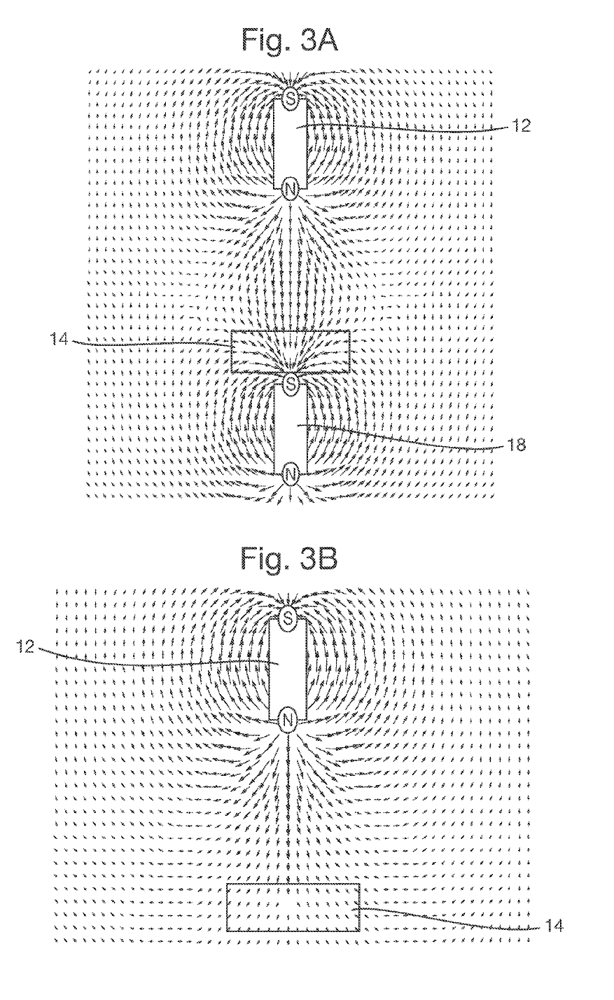

FIGS. 3A and 3B illustrate the effect of the magnetic focussing element 18. Comparing FIG. 3A, which has the magnetic focussing element 18, with FIG. 3B, which does not, it can be seen that the magnetic focussing element 18 causes an increase in the magnetic flux through the magnetic sensor element 14. As well as changing the magnitude of the flux it also modifies the shape of the magnetic field in the region of the magnetic field sensor 14. The change in the magnitude of the magnetic flux means that the effective zero-point for the device 10 is with a higher magnetic field passing through the magnetic field sensor 14 than would be the case without the focussing element 18. This provides a stronger signal from the magnetic sensor 14, obviating the need for signal amplification, and increasing the signal to noise ratio, and it allows a greater resolution and dynamic range for the sensor 14. The increased magnetic flux also reduces the relative influence of extraneous magnetic sources such as the earth's magnetic field or metallic objects which may be in the vicinity of the device.

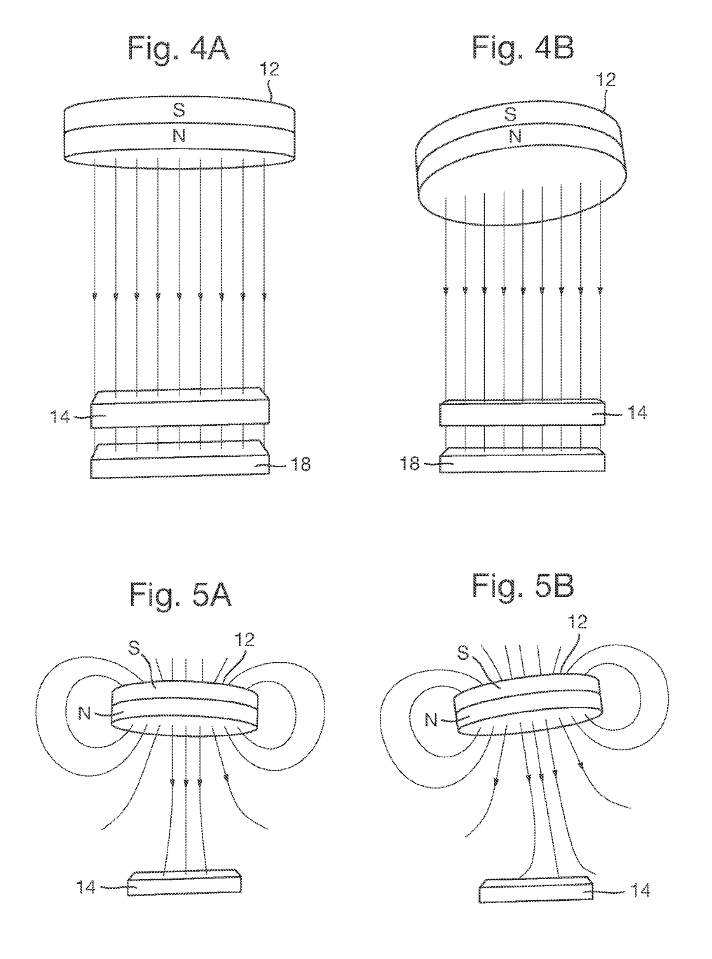

FIGS. 4A and 4B illustrate a further beneficial effect of the magnetic focussing element 18 which is that the magnetic field direction through the sensor 14 tends to be straighter and rendered less sensitive to tilt of the magnetic field generator 12. FIGS. 5A and 5B schematically illustrate the field through the magnetic field sensor 14 in the absence of a magnetic focussing element and it can be seen that the tilting of the magnetic field generator 12 has a greater effect on the field direction and magnitude at the magnetic field sensor 14. Tilting of the magnetic field generator 12 is a significant issue in the flexible and bendable device applications for which this invention is intended.

The magnetic focussing element 18 also provides a degree of physical self-alignment for the magnetic field generator 12 by virtue of the magnetic attraction between the magnetic field generator 12 and the magnetic focussing element 18.

Increasing the signal to noise ratio of the magnetic field sensor 14 by use of the magnetic focussing element 18 means that prior art methods of coping with low signal to noise ratio such as taking many measurements and averaging them, are not required. In turn this means that the device needs to be activated less frequently and can be operated in a “pulsed mode” where it is only activated periodically, with a period based on the particular application.

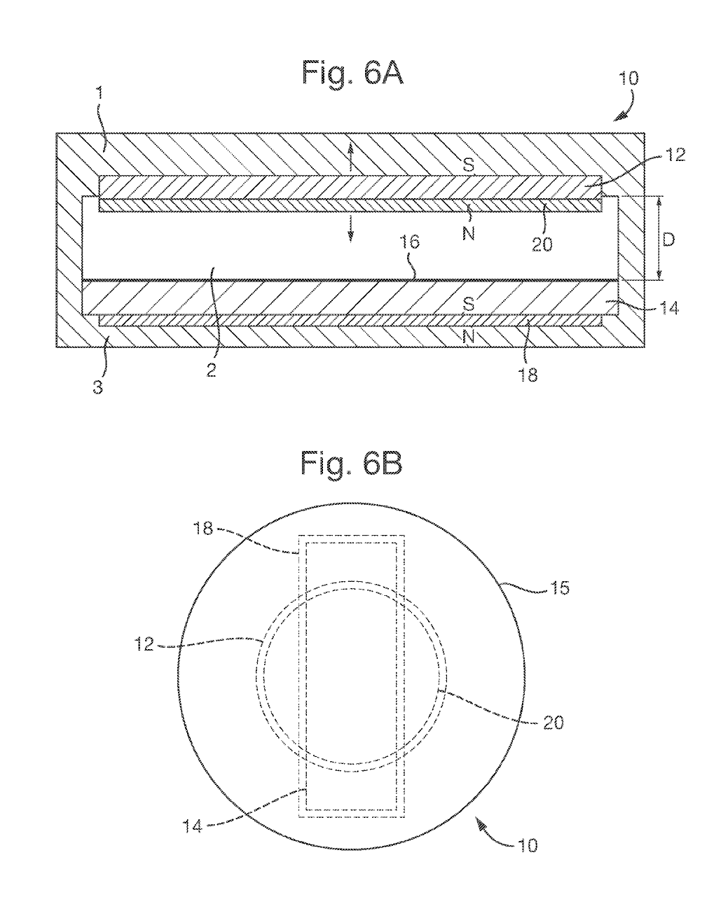

FIGS. 6A and 6B illustrate a second embodiment of the invention. This embodiment differs from the first embodiment only by the provision of a second magnetic field focussing element 20 provided adjacent to the magnetic field generator 12. This element 20 can be a permanent magnet, magnetized element or electromagnet or a high magnetic permeability material such as mu-metal or pure iron. It can be the same as or different from the magnetic focussing element 18. The additional magnetic focussing element 20 acts like a magnetic lens, further increasing the magnetic flux through the magnetic field sensor 14 enhancing the sensitivity, linearity, range and signal-to-noise ratio of the device. The second magnetic focussing element 20 is adjacent the magnetic field generator 12 between the magnetic field generator 12 and the magnetic field sensor 14. As illustrated it is in contact with it, but it may be spaced a small distance from it, for example with an intervening non-magnetic layer. It is at or near the side of the second layer 2 opposite the magnetic field sensor 14.

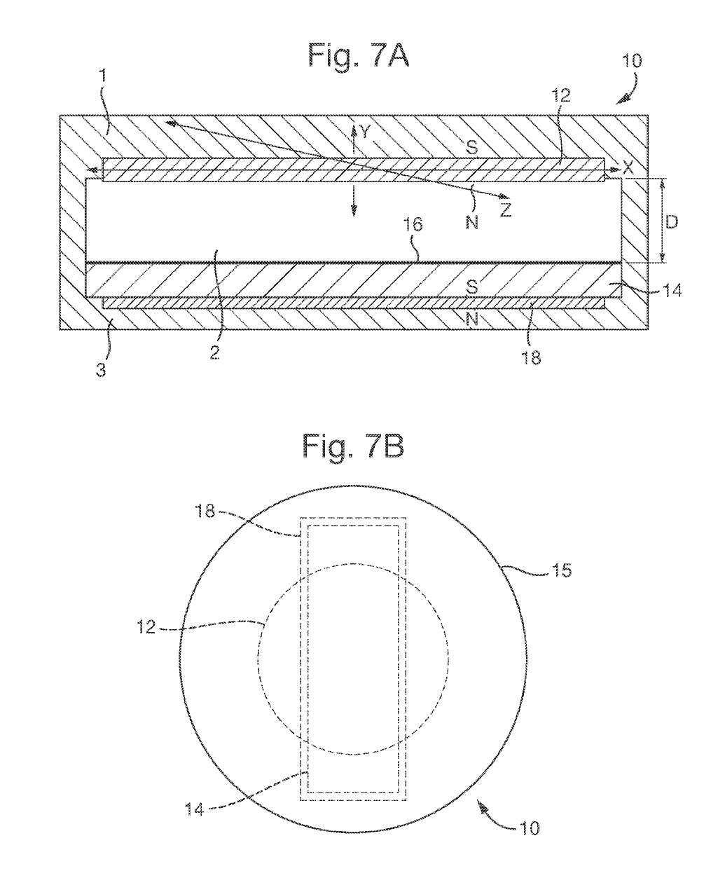

FIGS. 7A and 7B illustrate a third embodiment of the device of the invention. In this embodiment the magnetic field sensor 14 is an anisotropic magnetoresistance (AMR) or differential or giant magnetoresistance (DMR or GMR) sensor and the other components are as in the FIG. 1 embodiment. A single AMR, DMR or GMR sensor can be used to monitor both pressure and shear (i.e. lateral movement parallel to the top surface of the device 10) as it can track the movement of the magnetic field generator 12, in all 3 dimensions measuring thus pressure (y direction) and both anterior-posterior and lateral-medial shear (x and z directions). The movement of the magnet, in all three directions, can be then translated into pressure and shear (force) data by knowing the mechanical properties of the intermediate layer and by a calibration procedure of applying known loads and recording the displacement this has caused.

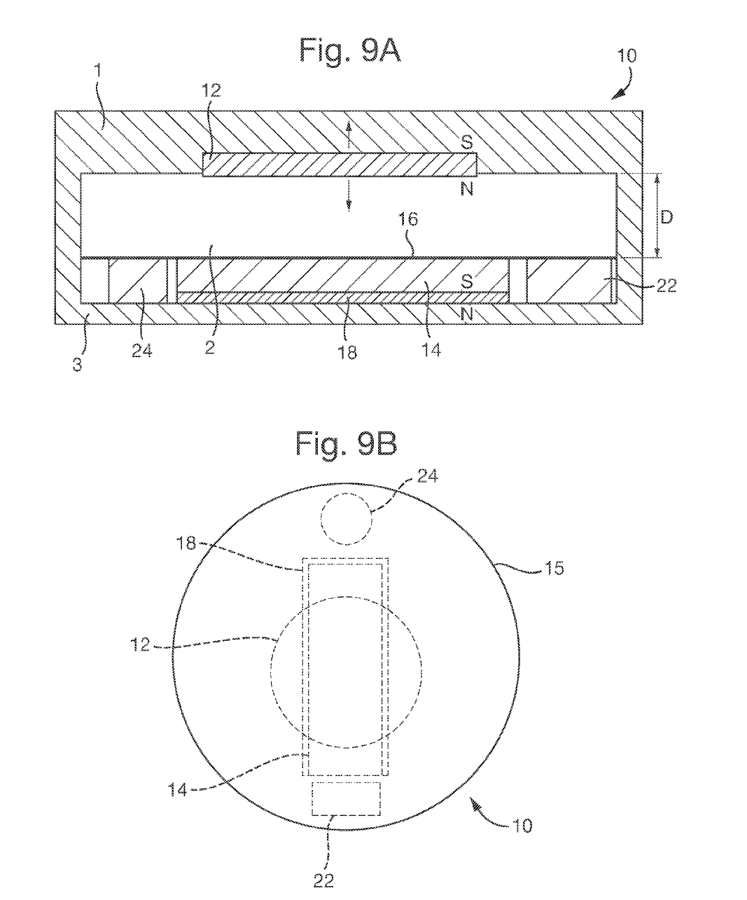

FIGS. 8A and 8B schematically illustrate how in a fourth embodiment the device 10 includes an onboard microcontroller and wireless communication module 22 in the layer 2. The programmable microcontroller and wireless communication module 22 is connected to the magnetic field sensor 14 by a printed circuit board 140 or flexible printed circuit board 140 or wires embedded in layer 2. FIGS. 9A and 9B illustrate the provision in a fifth embodiment within the device 10 of a power supply unit 24 for powering the magnetic field sensor 14 and the microcontroller and wireless communication module 22. The power supply unit 24 may include a rechargeable or replaceable battery or, in an alternative embodiment, can be a self-charging power supply such as one including a piezoelectric generator.

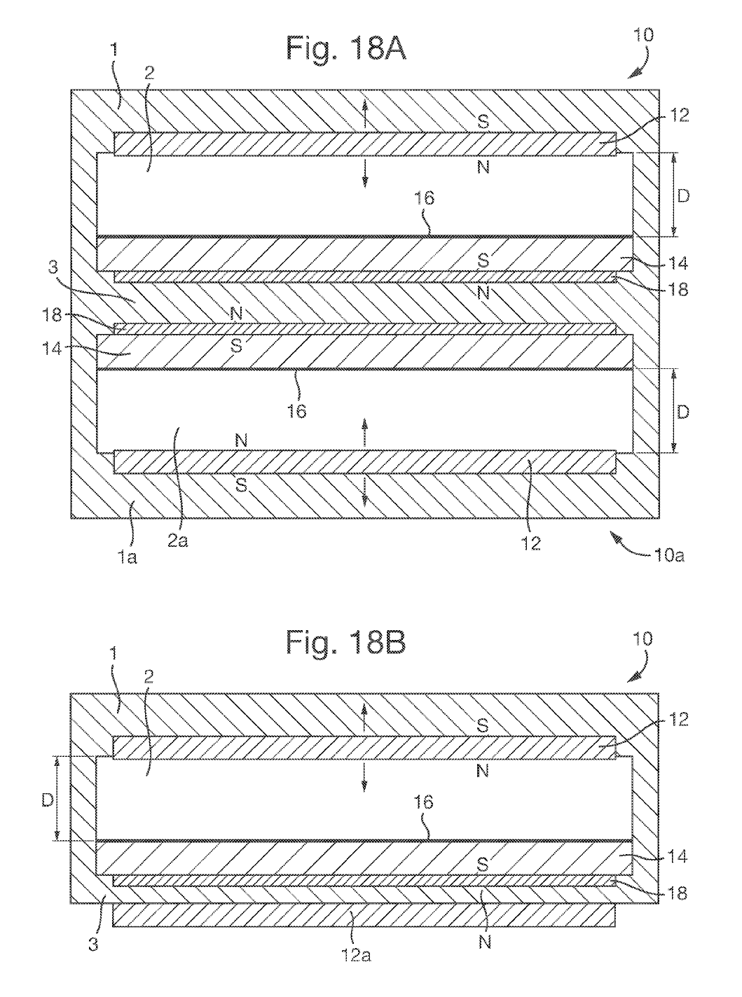

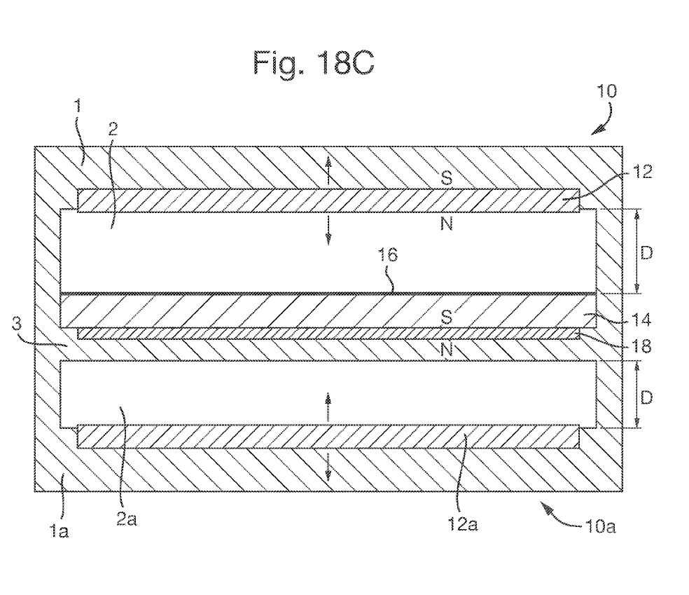

Two force sensing devices of the invention 10, 10a may also be combined back-to-back using a common third layer. This provides a bidirectional force sensing device. Alternatively a further magnetic field generator 12a may be located in the bottom of the third layer 3, or in a resilient support 1a 2a (the same as the illustrated layers 1 and 2 but inverted) underneath the third layer 3, so that the magnetic field sensors 14 are used in common for both magnetic field generators. These variations are illustrated in FIGS. 18A, B and C respectively.

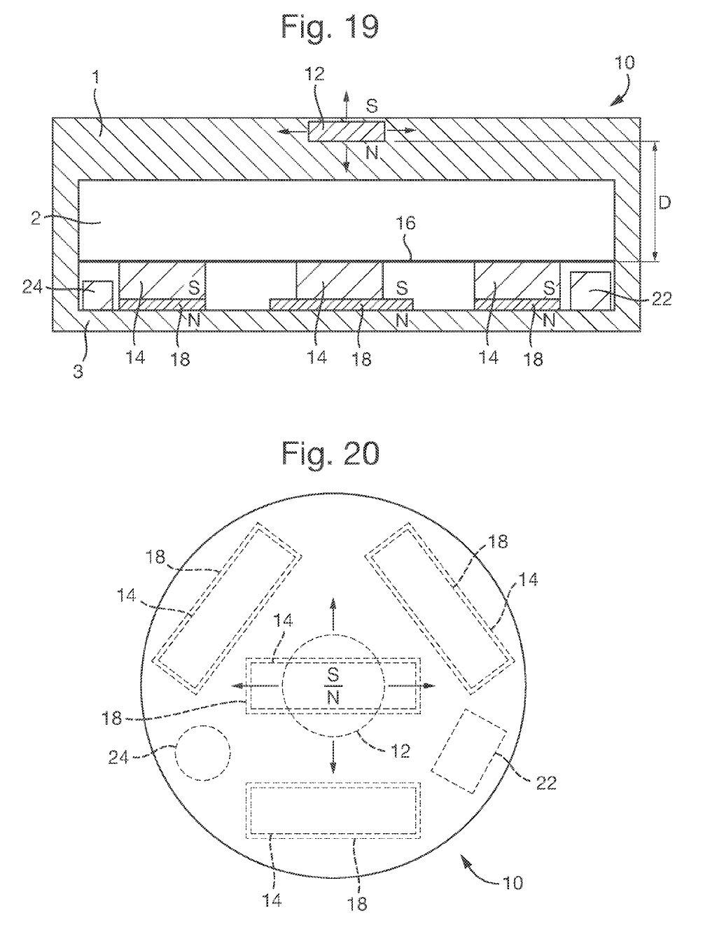

Some embodiments of the invention which include multiple sensors and focussing elements will now be described. Other parts are in common with the embodiments above. FIGS. 19 and 20 schematically illustrate a force sensing device in accordance with a sixth embodiment of the invention. The device comprises a magnetic field generator 12 which in this embodiment is a circular disk permanent magnet, such as ferromagnetic material magnets such as magnetite (Fe3O4) or Neodymium, which is spaced a distance D above an arrangement of, in this embodiment four, magnetic field sensors 14 which in this embodiment are Hall-effect sensors such as a Honeywell SS466A or a Honeywell SS30AT, though other types of magnetic field sensor can be used. A variety of MEMS magnetometers are available. The spacing D is provided by mounting the magnetic field generator 12 in a layer 1 made of flexible and bendable material such as poron, foam, EVA, silicone, silicone gel or urethane and providing a second layer 2 between the magnetic field generator 12 and magnetic field sensors 14. The layer 2 is a flexible and bendable material such as poron, foam, EVA, silicone, silicone gel and urethane, or can be or contain a sealed air-filled cushion. The layers 1 and 2 act together as a resilient support which allow relative movement of the magnetic field generator 12 and magnetic field sensors 14 varying the distance D. The layer 1 may be provided with rigid parts, e.g. sides or top, made from metal or plastic which form a device casing 15. A protective film 16 of PVC or high density foam or hard silicon can be provided between the second layer 2 and the magnetic field sensors 14.

On the opposite side of the magnetic field sensors 14 from the magnetic field generator 12 are provided respective magnetic focussing elements 18. Each of these can be a permanent magnet or magnetized element or electromagnet, or alternatively a high magnetic permeability material such as a mu-metal or pure iron. The magnetic focussing elements 18 are oriented with their magnetic poles in the same orientation as the magnetic field generator 12. Thus as illustrated in FIG. 19 in both cases the south pole is uppermost and north pole lowermost. In an alternative arrangement the respective magnetic focussing (and shielding) elements 18 may be combined into a single sheet-like element for the whole device 10.

The bottom of the device 10 is covered with a third layer 3, again made of a flexible and bendable material such as poron, foam, EVA, silicone, silicone gel or urethane which acts as a protective layer for the magnetic field sensor 14. The layer 3 can be omitted in an alternative embodiment or can be made of a rigid material such as metal or plastic if the device as whole does not need to be bendable.

As illustrated in FIG. 19, the layer 2 may also accommodate electronic instrumentation for running the device 10. It therefore may contain a power supply unit 24, comprising a battery, for example a rechargeable battery, and a programmable microcontroller and wireless communication unit 22 for controlling the magnetic field sensor 14 and processing the pressure measurements and transmitting them to a remote device 50 (see FIG. 17). The power supply unit 24, magnetic field sensors 14, microcontroller and wireless communication unit 22 are interconnected by means of a printed circuit board 140 (see FIGS. 13 to 16) or flexible printed circuit board 140, though they can be connected by wires. Preferably the microcontroller and wireless communication unit 22 are incorporated into a single unit (chip) to save space and power. Although the battery is described as a rechargeable battery, it can be a replaceable battery or a self-charging mechanism which charges in response to distortion of the pressure sensor (for example a piezoelectric charging mechanism). Alternatively the power supply unit 24 and the microcontroller and wireless communication unit 22 may be separate from the device 10 rather than being integrated with it.

In operation the magnetic field sensors 14 are powered by the power supply unit 24 in the device 10 and senses and records changes in the magnitude of the magnetic field from the magnetic field generator 12 caused by relative movement of the magnetic field generator 12 and magnetic field sensors 14 in response to force and pressure changes applied to the device 10. Such force or pressure causes the layers 1 and 2 to deform resulting in relative vertical and/or lateral displacement of the magnetic field generator 12 and magnetic sensor elements 14 changing distance D. The changes in magnetic field sensed by the magnetic field sensors 14 are translated into voltage changes which are recorded by the programmable microcontroller unit and converted into force and pressure readings by means of an on-board calibration which correlates voltage changes with corresponding load values. Such calibration can be achieved in an initial calibration process in which known forces are applied to the device 10 while recording the voltage output from the magnetic field sensor 14. Shear forces can be calculated by triangulating the readings of the magnetic field recorded by the magnetic field sensors 14 and this calculation can take place in the programmable microcontroller 22 or in the remote unit 50 to which the data is transmitted. In the medical field, or where high accuracy is required, each sensor can be individually calibrated and the calibration results stored in the programmable microcontroller or the remote module 50. In health and fitness applications, where lower accuracy is acceptable, but lower cost important, only samples of batches need to be calibrated and the results stored for all sensors of the batch.

The processed or unprocessed readings are then output wirelessly to a remote data recording, analysis and display module 50 (see FIG. 17) such as a software application running on a personal computer, tablet computer or smartphone. The readings may be passed raw to the wireless communication unit 22 to be processed at the remote module 50. The readings may be compressed for transmission. Further, some processing, such as conversion by way of calibration data may be conducted by the microprocessor 22. As well as communicating with the remote module 50, the device 10 can be provided with network connectivity so that it can wirelessly communicate with other devices 10 to exchange data and to exchange control signals. For example, the data acquisition rate of each device 10 may be changed based on signals from the central module 50 or from other devices 10.

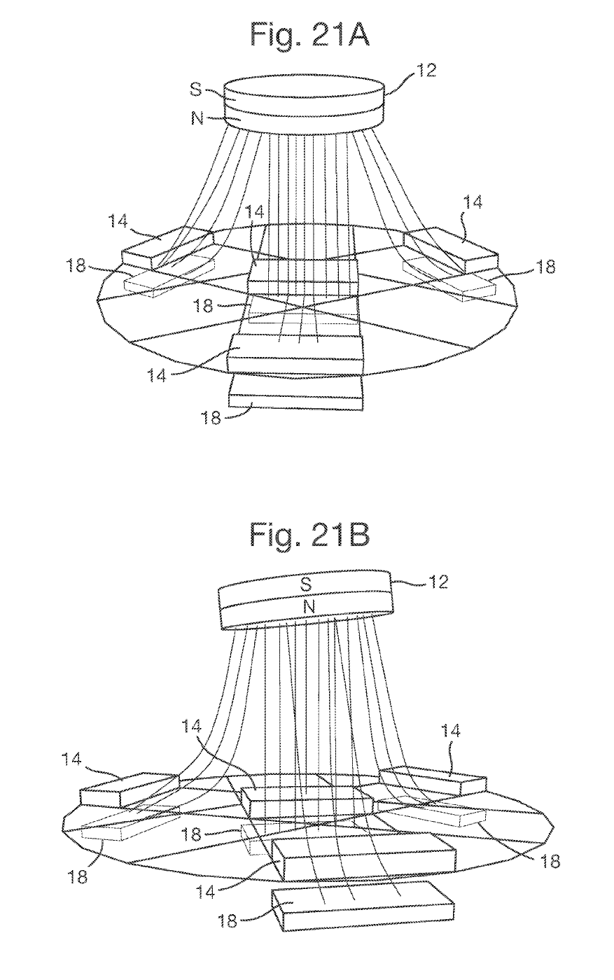

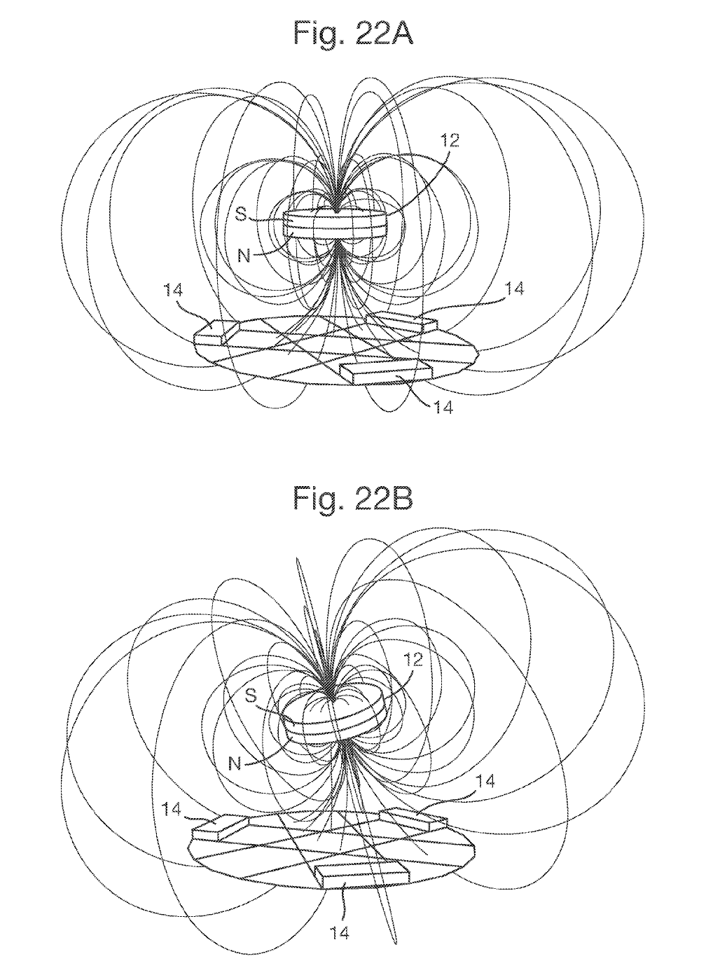

FIGS. 21A and 21B illustrate the effect of the magnetic focussing elements 18, which is that the magnetic field direction through the magnetic field sensors 14 tends to be straighter and rendered less sensitive to tilt of the magnetic field generator 12. FIGS. 22A and 22B schematically illustrate the field through the magnetic field sensors 14 in the absence of a magnetic focussing element and it can be seen that the tilting of the magnetic field generator 12 has a greater effect on the field direction and magnitude at the magnetic field sensors 14. Tilting of the magnetic field generator 12 is a significant issue in the flexible and bendable sensor applications for which this invention is intended.

The magnetic focussing elements 18 also provides a degree of physical self-alignment for the magnetic field generator 12 by virtue of the magnetic attraction between the magnetic field generator 12 and the magnetic focussing elements 18.

Increasing the signal to noise ratio of the magnetic field sensors 14 by use of the magnetic focussing elements 18 means that prior art methods of coping with low signal to noise ratio such as taking many measurements and averaging them, are not required. In turn this means that the force sensing device needs to be activated less frequently and can be operated in a “pulsed mode” where it is only activated periodically, with a period based on the particularly application.

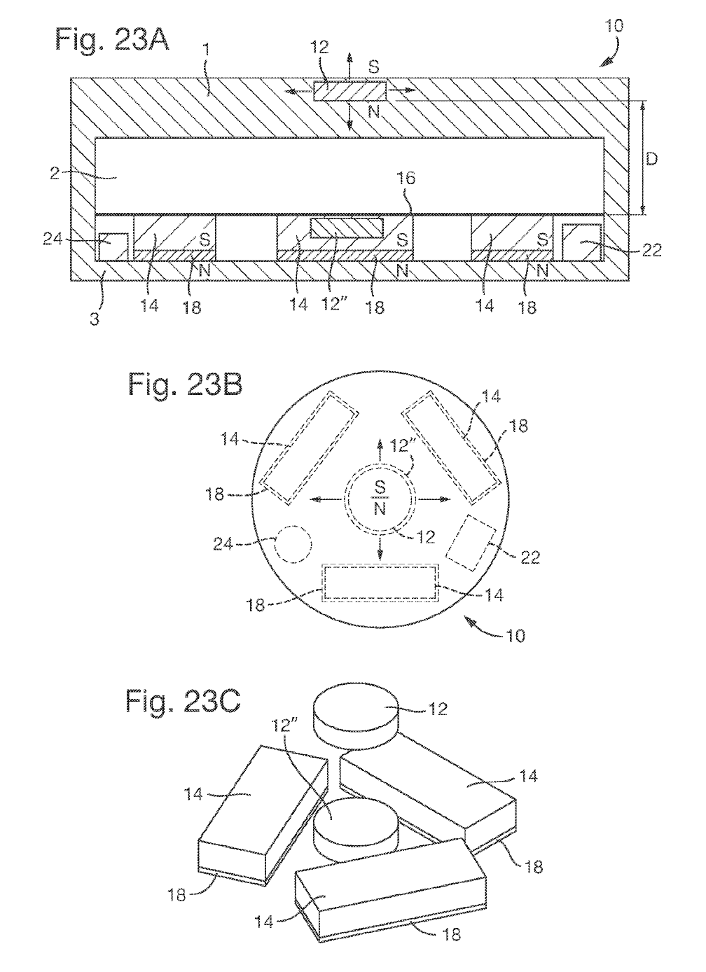

FIGS. 23A, B and C illustrate a seventh embodiment of the invention. This embodiment differs from the sixth embodiment only by the provision of a second magnetic field generator 12″ provided axially below the magnetic field generator 12 and in layer 2, i.e. in the same plane as in the arrangement of the magnetic field sensors 14. Other components are the same as illustrated in FIGS. 19 and 20. The additional magnetic field generator element 12″ can be a permanent magnet, magnetized element or electromagnet. It can be the same as or different from the magnetic field generator 12. The second magnetic field generator 12″ acts to further increase the magnitude and linearity of the magnetic flux through the magnetic field sensors 14 enhancing the sensitivity, linearity, range and signal-to-noise ratio of the device 10. As shown in the schematic isometric view of the main components of FIG. 23C, the magnetic field sensors are disposed axially symmetrically around the second magnetic field generator 12″.

Although the device 10 is illustrated in the drawings with the layer 1 uppermost and layer 3 lowermost, the orientation in use of the device is unimportant. It will function effectively with pressure or forces applied to layer 3 or layer 1 or both and with the device in any orientation.

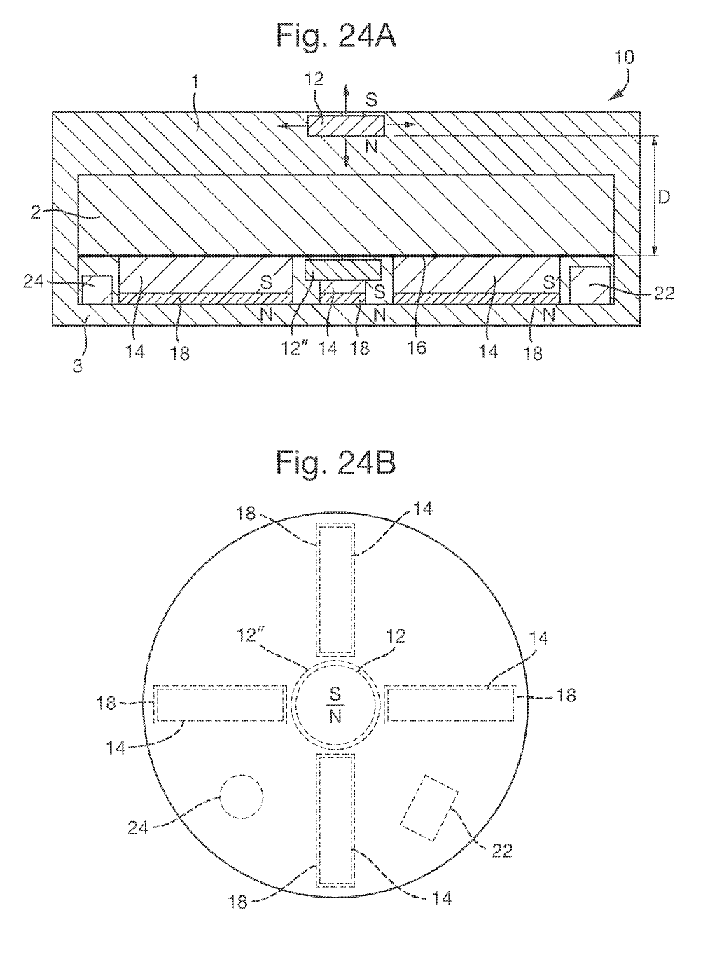

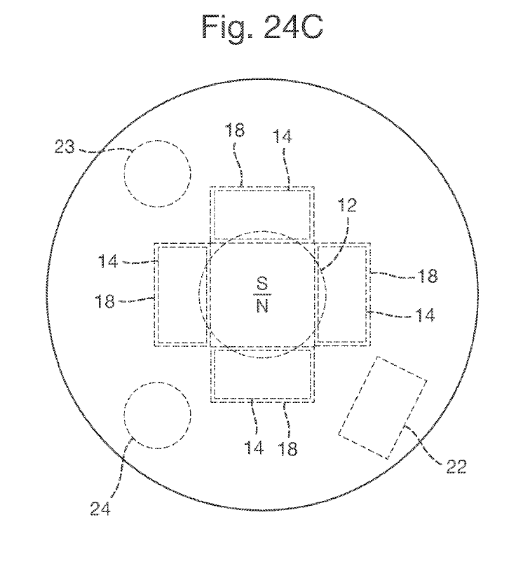

FIGS. 24A, B and C illustrate an eighth embodiment of the invention in which four magnetic field sensors 14 are disposed in a cross-shaped arrangement either with the additional magnetic field generator 12″, or without, as in FIG. 24C. The aim of this arrangement is to provide a highly efficient magnetic sensor configuration to measure forces in all three directions. The triangular formations illustrated above can have low accuracy and resolution especially in the x and y axes, and to require intensive signal processing in order to produce meaningful results because they use polar geometry to calculate the magnet field variations. In contrast the four sensor system (FIGS. 24A, B and C) utilise orthogonally placed magnetic sensors which provide the position of the magnet by direct subtraction (x and y axes). At the same time mechanical assembly and alignment of the magnetic sensors becomes much easier and the resolution and accuracy of the system increases tenfold.

Much less signal processing is required with the four sensors cross-square configuration.

As a magnet moves farther from a sensor, the output decreases. More precisely, close to the magnet face, the magnet is like a monopole, so the field drops off with the square of the distance. Farther from the face, the field decreases with the cube of the distance. It is difficult to predict the exact relationship theoretically due to flux density of the magnetic field at various distances. This is the main problem that the three sensor configuration faces and the reason why it requires intensive signal processing. However this does not affect the four sensor configuration as it does not directly calculates the field density; it just subtracts the values from the two opposite x-axis sensors and the two opposite y-axis sensors to give the measurements in the x and y directions and by summing all four sensors' outputs the z-axis measurement is obtained. This lighter processing burden is especially useful for on-board processing applications where power supply and space requirements are tight. Again, in an alternative arrangement the respective magnetic focussing (and shielding) elements 18 may be combined into a single sheet-like element for the whole device 10 if desired.

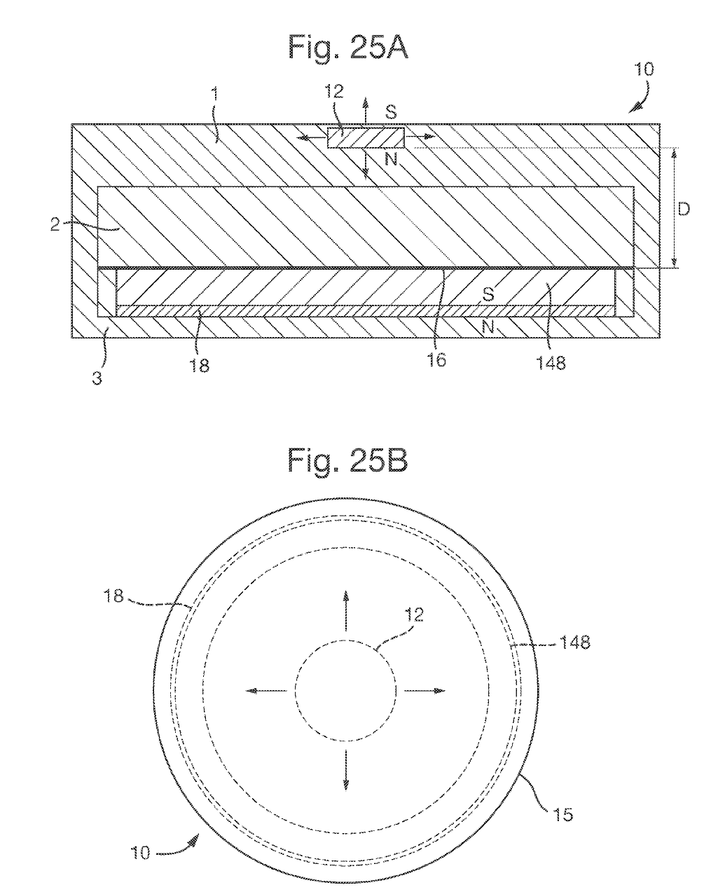

FIGS. 25A and B schematically illustrate a ninth embodiment of the invention in which the magnetic field sensors and magnetic focussing elements are integrated into a circular array 148 which is positioned with its axis aligned with the axis of the magnetic field generator 12. Such an array 148 can comprise 8, 12 or even hundreds of individual magnetic sensor elements 14 and corresponding magnetic focussing elements 18 to provide increased shear force detection performance and accuracy.

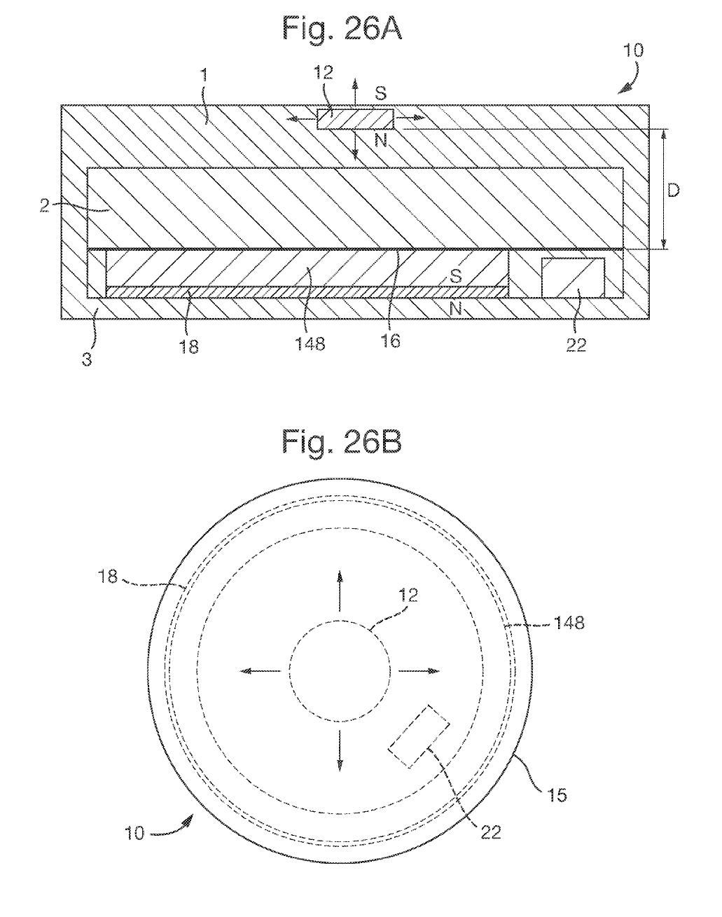

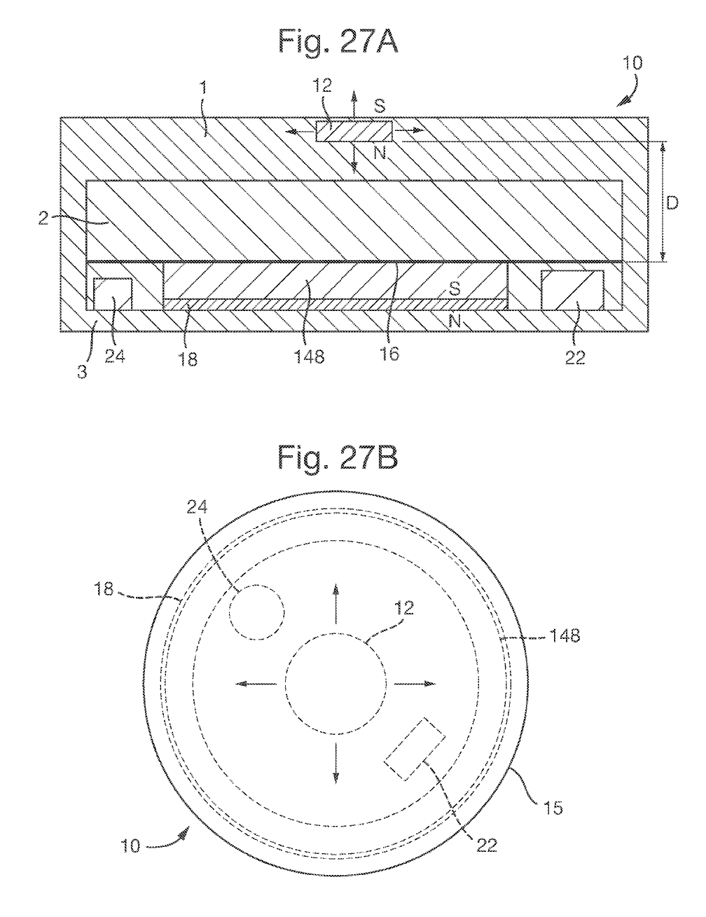

In the ninth embodiment of FIG. 25A and B the device 10 does not include its own on board microcontroller and wireless communication unit 22 or power supply 24. These are provide separately from the sensor 10. FIGS. 26A and B illustrate that the device 10 can be adapted to include an on board microprocessor and wireless communication unit 22 (in the form of a Bluetooth module). In the tenth embodiment of FIGS. 26A and 26B the power supply is provided separately, but FIGS. 27A and 27B illustrate a eleventh embodiment which is further modification in which a power supply unit 24 which can be the same as the power supply unit 24 described above, is incorporated into the device 10.

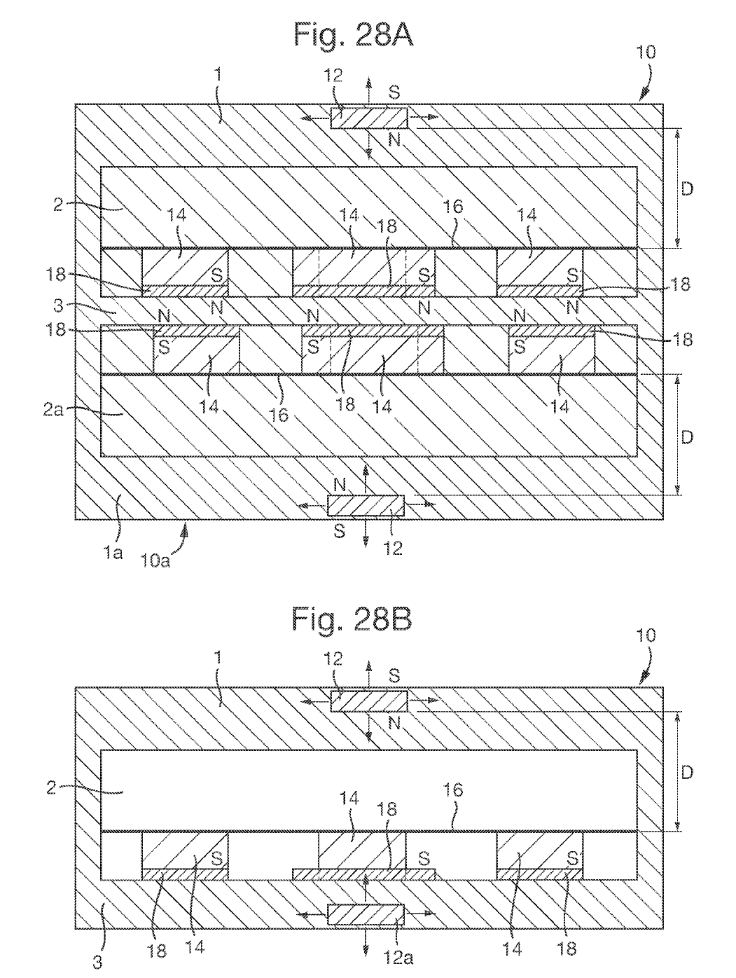

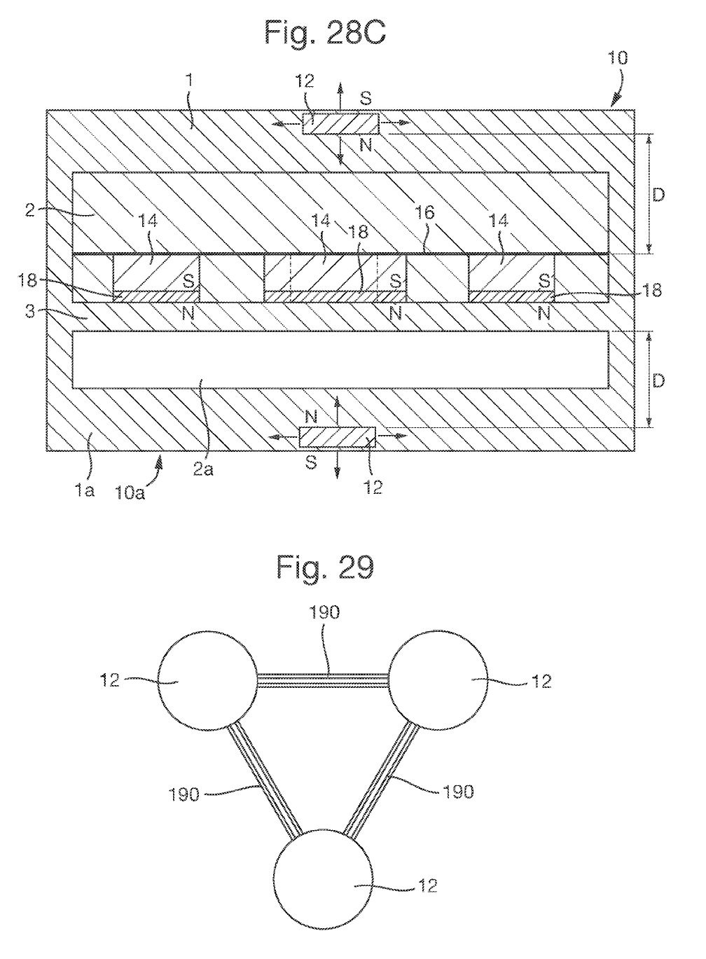

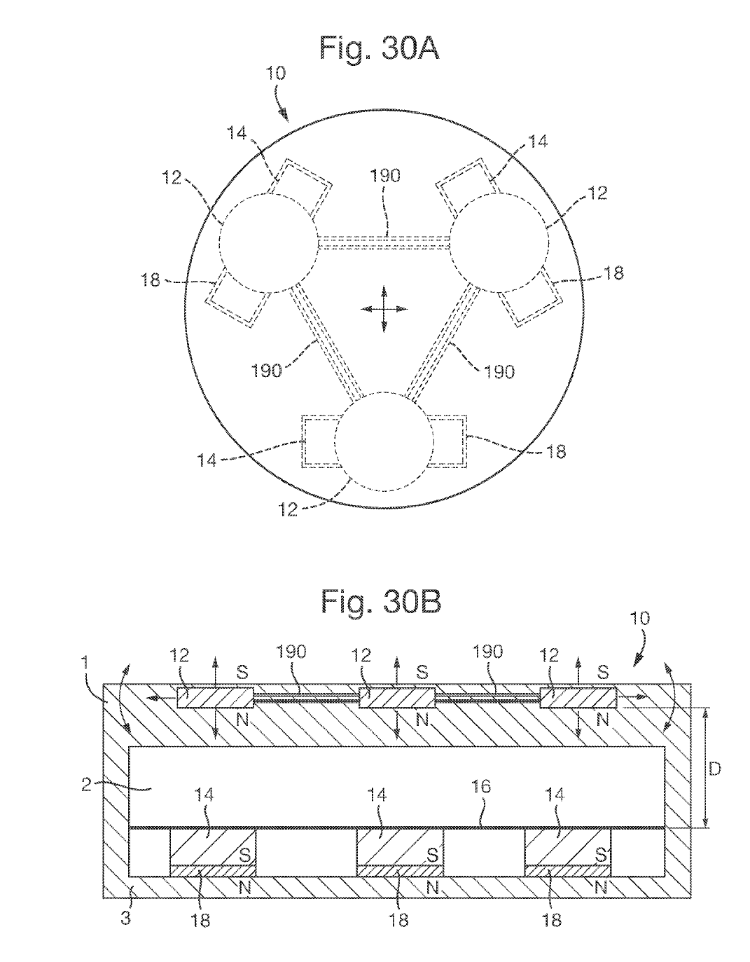

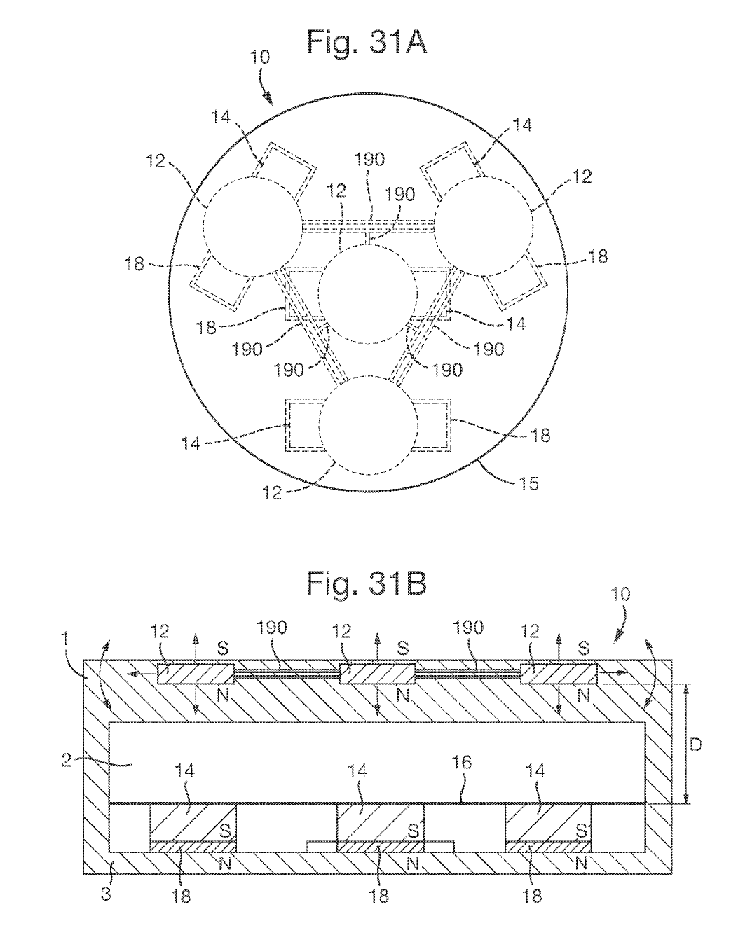

As before two force sensing devices of the invention 10, 10a may also be combined back-to-back using a common third layer. This provides a bidirectional force sensing device. Alternatively a further magnetic field generator 12a may be located in the bottom of the third layer 3, or in a resilient support 1a 2a (the same as the illustrated layers 1 and 2 but inverted) underneath the third layer 3, so that the magnetic field sensors 14 are used in common for both magnetic field generators. These arrangements are illustrated in FIGS. 28A-C.

Any of the above embodiments may be modified by the provision of a second magnetic field focussing element provided adjacent to the magnetic field generator 12. This element can be a permanent magnet, magnetized element or electromagnet or a high magnetic permeability material such as mu-metal or pure iron. It can be the same as or different from the magnetic focussing element 18. The additional magnetic focussing element acts like a magnetic lens, further increasing the magnetic flux through the magnetic field sensor 14 enhancing the sensitivity, linearity, range and signal-to-noise ratio of the device. The second magnetic focussing element is preferably positioned adjacent the magnetic field generator 12 between the magnetic field generator 12 and the magnetic field sensor 14. It can be in contact with it, but it may be spaced a small distance from it, for example with an intervening non-magnetic layer. It is at or near the side of the second layer 2 opposite the magnetic field sensor 14.

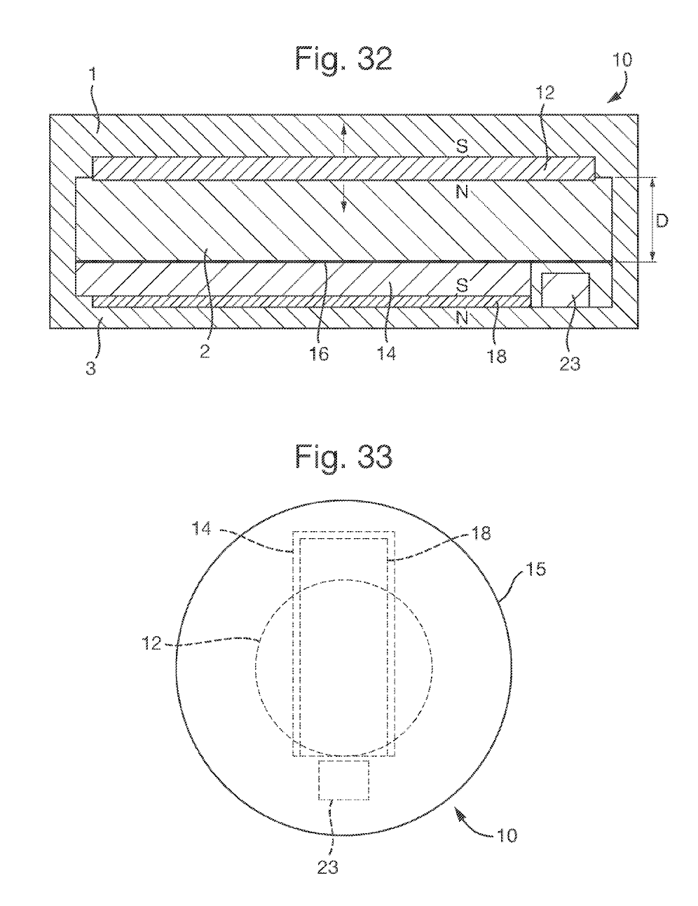

Embodiments of the invention which include a motion/orientation sensor will now be described. These embodiments are otherwise constructed as those above and so the description of common parts will not be repeated. FIGS. 32 and 33 schematically illustrate a force sensing device 10 in accordance with a twelfth embodiment of the invention. The device 10 is as described above except that the layer 2 also houses a motion/orientation sensor unit 23. In this embodiment the motion sensor unit 23 also comprises an orientation sensor for sensing the orientation of the device and the motion sensor unit 23 may comprise at least one of: a piezoelectric sensor, a gyroscopic sensor, a 2-axis accelerometer, a 3-axis accelerometer. The motion sensor and orientation sensor may be integrated with each other, and either or both may be integrated with the magnetic field sensor in a MEMS-type device such as a STMicroelectronics LSM330DLCiNEMO inertial module or a Kionix KMX61G or a InvenSense MPU-6050.

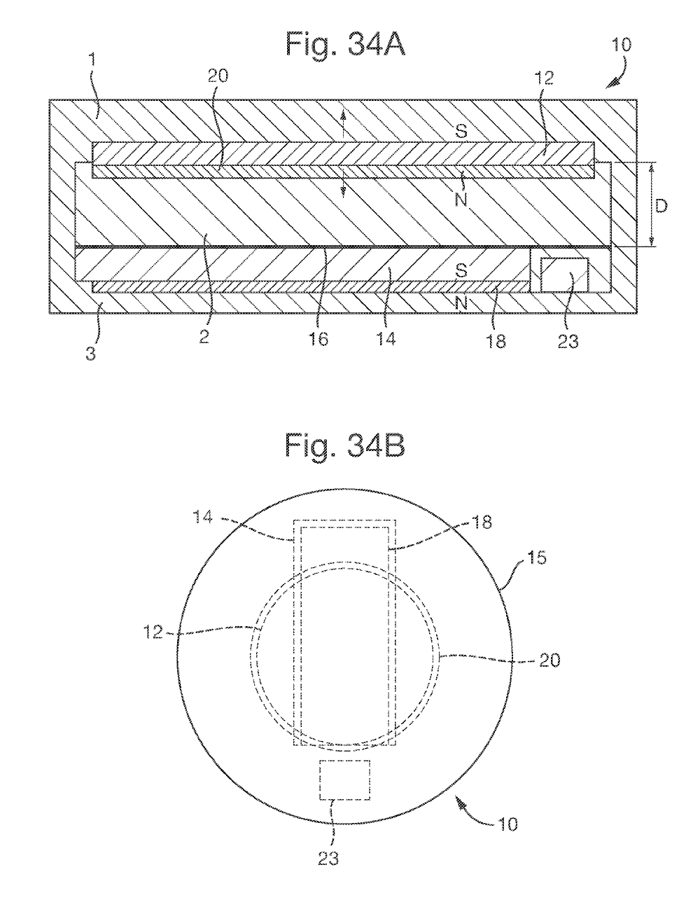

Although not illustrated in FIG. 32, as shown in FIGS. 34A, B and 35A, B, the layer 2 may also accommodate electronic instrumentation for running the device 10 in the same way as described above. The power supply unit 24, magnetic field sensor 14, motion/orientation sensor unit 23, microcontroller and wireless communication unit 22 are interconnected by means of a printed circuit board 140 (see FIGS. 13 to 17) or flexible printed circuit board 140, though they can be connected by wires. Preferably the microcontroller and wireless communication unit 22 are incorporated into a single unit (chip) to save space and power. Although the battery is described as a rechargeable battery, it can be a replaceable battery or a self-charging mechanism which charges in response to distortion of the device (for example a piezoelectric charging mechanism).

In operation the motion sensor 23 outputs readings of acceleration and orientation which are passed to the microcontroller 22.

The processed or unprocessed readings are then output wirelessly to a remote data recording, analysis and display module 50 (see FIG. 17) such as a software application running on a personal computer, tablet computer or smartphone. The readings may be passed raw to the wireless communication unit 22 to be processed at the remote module 50. The readings may be compressed for transmission. Further, some processing, such as conversion by way of calibration data may be conducted by the microprocessor 22. As well as communicating with the remote module 50, the device 10 can be provided with network connectivity so that it can wirelessly communicate with other devices 10 to exchange data and to exchange control signals. For example, the data acquisition rate of each device 10 may be changed based on signals from the central module 50 or from other devices 10.

FIGS. 34A and B illustrate a thirteenth embodiment of the invention. This embodiment differs from the twelfth embodiment only by the provision of a second magnetic field focussing element 20 provided adjacent to the magnetic field generator 12.

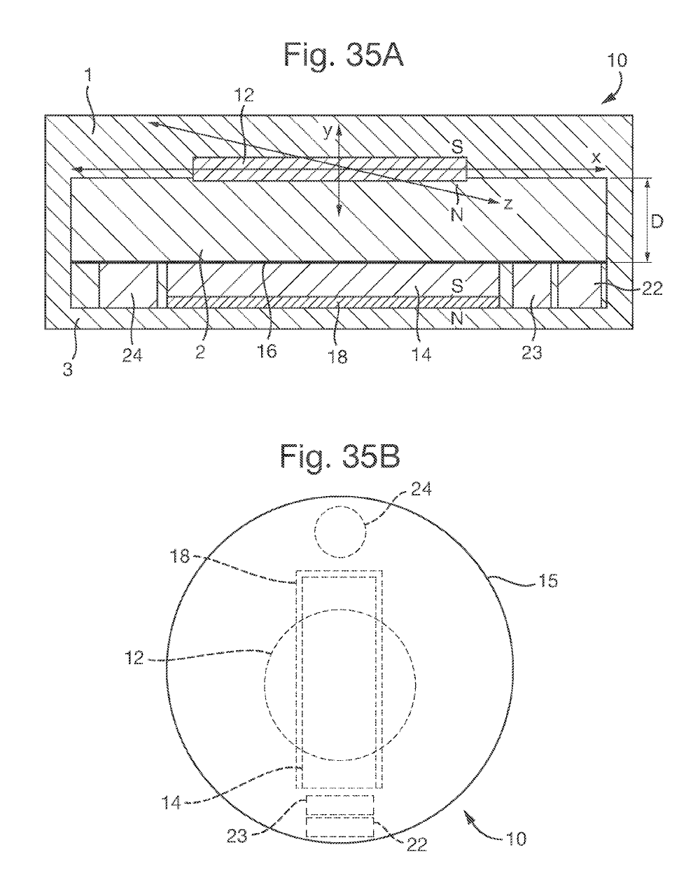

FIGS. 35A and B illustrate a fourteenth embodiment of the pressure sensor of the invention. In this embodiment the first layer 1 contains the magnetic field sensor 14, which is in this case anisotropic magnetoresistance (AMR) or differential or giant magnetoresistance (DMR or GMR) sensor and the other components are as in the FIG. 32 embodiment.

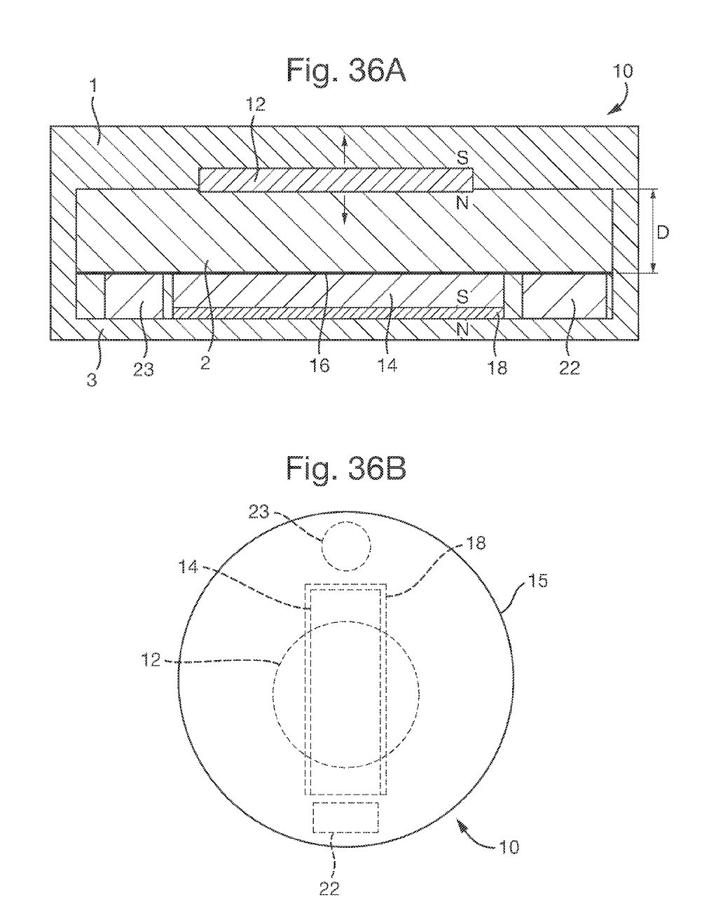

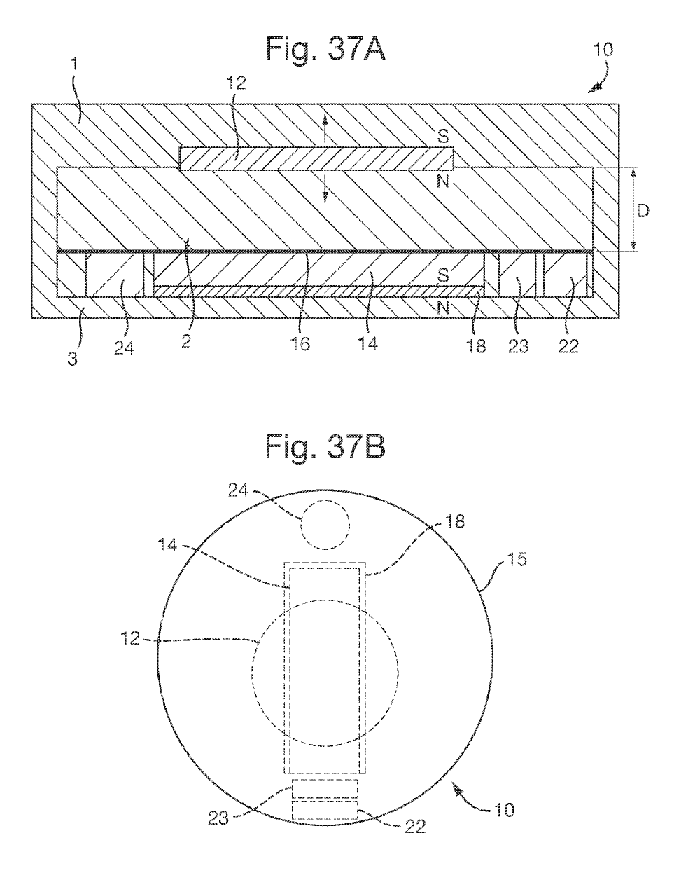

FIGS. 36A and B schematically illustrate how in a fifteenth embodiment the device 10 includes an on-board microcontroller and wireless communication module 22 in the layer 2. The programmable microcontroller and wireless communication module 22 is connected to the magnetic field sensor 14 by a printed circuit board 140 or flexible printed circuit board 140 or wires embedded in layer 2. FIGS. 37A and B illustrate in a sixteenth embodiment the provision within the device 10 of a power supply unit 24 for powering the magnetic field sensor 14, motion sensor 23 and the microcontroller and wireless communication module 22. The power supply unit 24 may include a rechargeable or replaceable battery or, in an alternative embodiment, can be a self-charging power supply such as one including a piezoelectric generator.

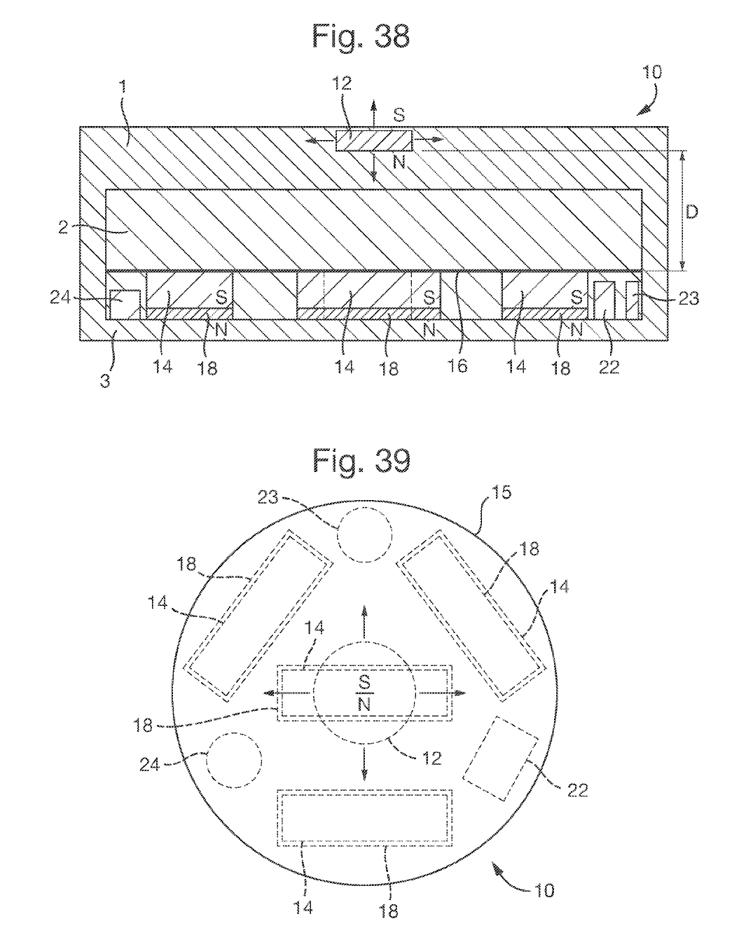

FIGS. 38 and 39 schematically illustrate a seventeenth embodiment which is a force sensing device 10 which in addition to the force and motion measurements discussed above can measure shear forces applied to the device. The device 10 comprises a magnetic field generator 12 as above which is spaced a distance D above an arrangement of, in this embodiment four, of the magnetic field sensors 14 such as Hall-effect sensors, though other types of magnetic field sensor can be used. The other aspects of the device are the same as for FIG. 32 above.

As illustrated in FIG. 38, the layer 2 also accommodates the motion sensor 23 and optionally electronic instrumentation 22, 24 for running the device 10, again as explained above.

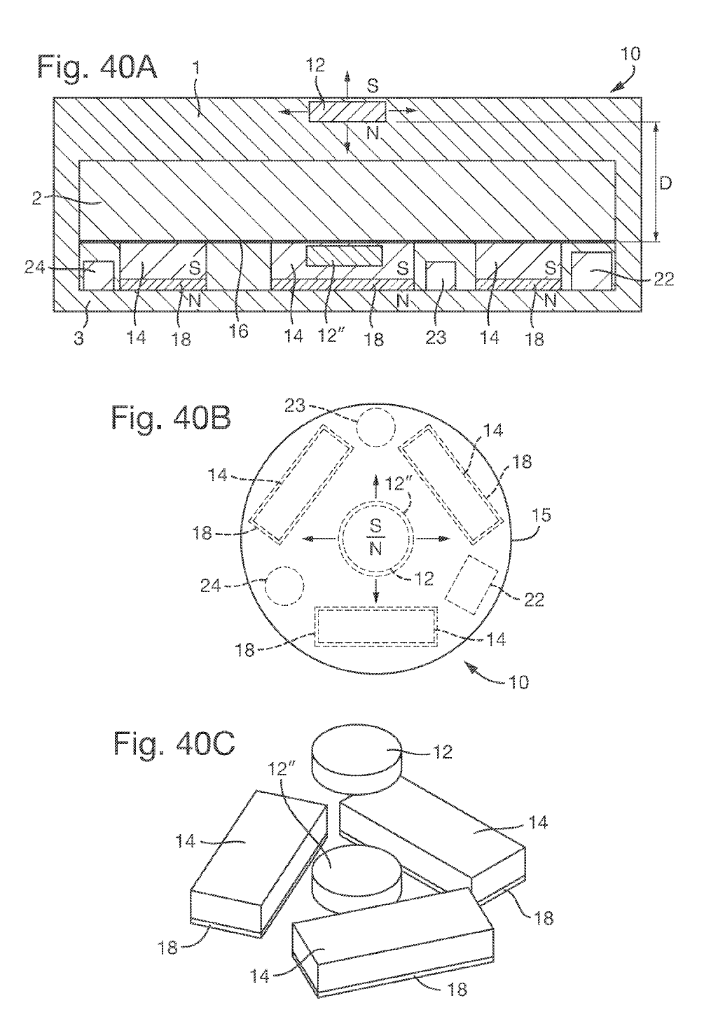

FIGS. 40A, B and C illustrate an eighteenth embodiment of the invention. This embodiment differs from the previous embodiments only by the provision of a second magnetic field generator 12″ provided axially below the magnetic field generator 12 and in layer 2, i.e. in the same plane as in the arrangement of the magnetic field sensors 14. Other components are the same as illustrated in FIGS. 38 and 39.

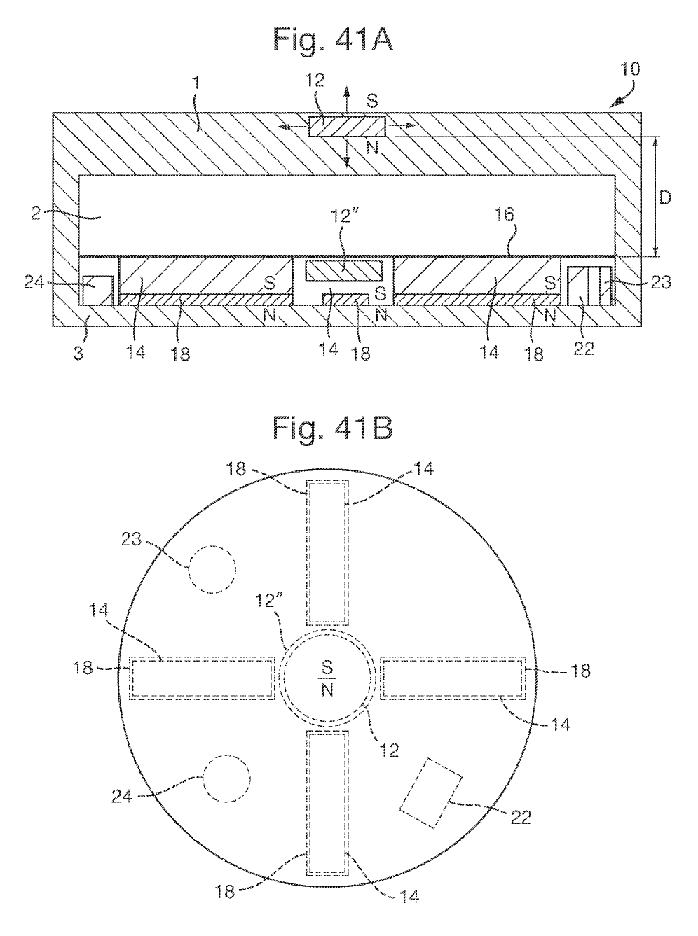

FIGS. 41A and B illustrate a nineteenth embodiment of the invention in which four magnetic field sensors 14 are disposed in a cross-shaped arrangement but otherwise is as illustrated in FIGS. 40A and B.

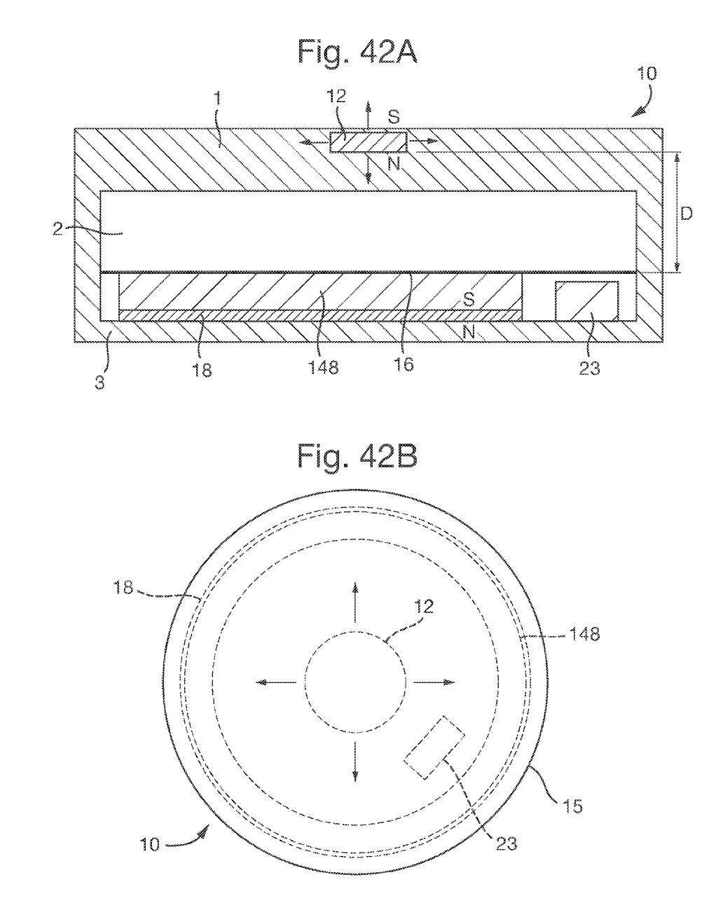

FIGS. 42A and B schematically illustrate an twentieth embodiment of the invention in which the magnetic field sensors 14 and magnetic focussing elements 18 are integrated into a circular array 148 which is positioned with its axis aligned with the axis of the magnetic field generator 12. Such an array 148 can comprise 8, 12 or even hundreds of individual magnetic sensor elements 14 and corresponding magnetic focussing elements 18 to provide increased shear force detection performance and accuracy.

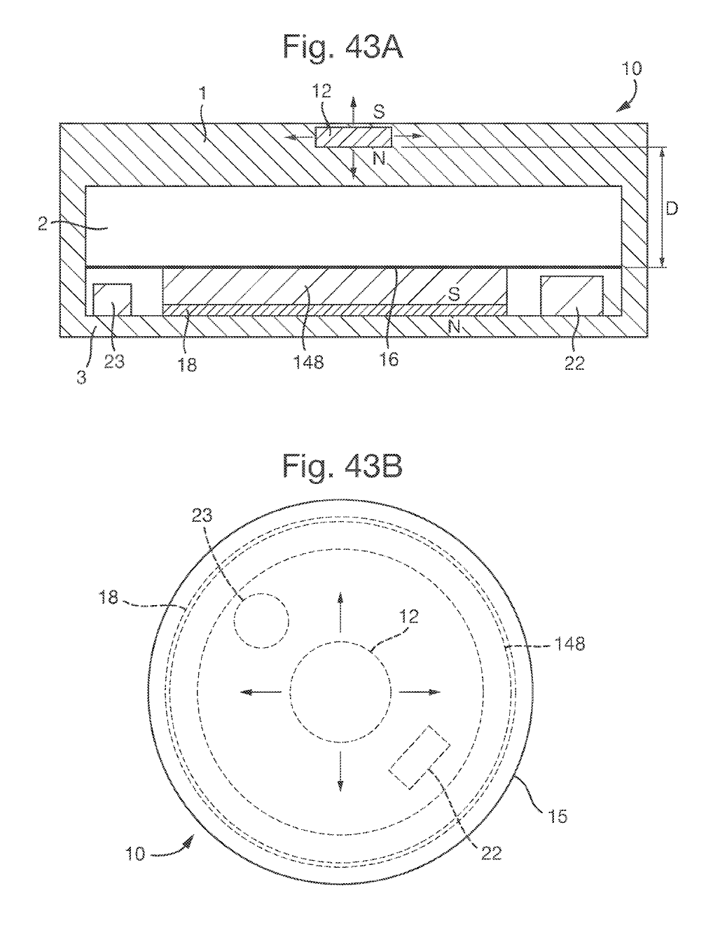

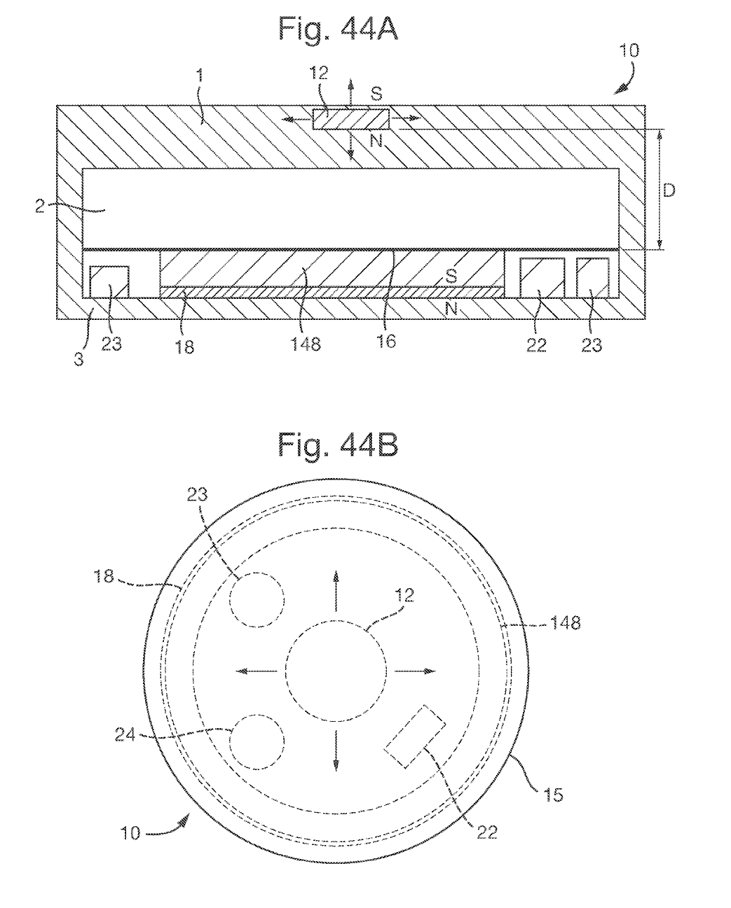

In the embodiment of FIGS. 42A and B the device 10 does not include its own on-board microcontroller and wireless communication unit 22 or power supply 24. These are provide separately from the sensor 10. FIGS. 43A and B illustrate that the device 10 can be adapted to include an on board microprocessor and wireless communication unit 22 (in the form of a Bluetooth module). In the twenty first embodiment of FIGS. 43A and B the power supply is provided separately, but FIGS. 44A and B illustrate a further modification in which a power supply unit 24 which can be the same as the power supply unit 24 described above, is incorporated into the sensor 10.

As before, two force sensing devices of the invention 10, 10a may also be combined back-to-back using a common third layer. This provides a bidirectional force sensing device. Alternatively a further magnetic field generator 12a may be located in the bottom of the third layer 3, or in a resilient support 1a 2a (the same as the illustrated layers 1 and 2 but inverted) underneath the third layer 3, so that the magnetic field sensors 14 are used in common for both magnetic field generators.

It will be appreciated that the device 10 can include its own controller and communications module 22 and its own power supply unit 24, or these functions can be provided from the outside. Furthermore, although the device 10 is illustrated in the drawings with the layer 1 uppermost and layer 3 lowermost, the orientation in use of the device is unimportant. It will function effectively with pressure or forces applied to layer 3 or layer 1 or both and with the device in any orientation.

The device 10 may also incorporate a temperature sensor. Any type of commercial analog and/or digital temperature sensor can be used. The sensor is powered by the power supply 24 and the output signal from the temperature sensor is supplied to the controller and communications module 22 for transmission with the force measurements. Monitoring and recording temperature at different intervals can be a very helpful tool for preventing ulceration and skin breakage. It has been reported that even as early as a week before ulceration the temperature of the area that is to be affected displays an elevation (up to 5C) in temperature. Therefore, accurate temperature recordings can act as an early warning system; stopping the ulceration from growing and becoming a serious problem and even prevent it.

The devices 10 described above can be incorporated into a variety of products. For example one or more devices can be incorporated into an insole of a shoe, or into the sole structure of a shoe itself, or into a seat, cushion, mattress or saddle or any product where it is desired to measure the applied force or pressure. Where plural devices 10 are used the microcontrollers and wireless communication modules 22 may be adapted to provide for intercommunication between the devices 10 themselves as mentioned above. The use of plural devices will be described in more detail below with reference to embodiments of the invention in which the principle components of the invention are incorporated into products by using the structure of the products themselves to provide the layers 1, 2 and 3 supporting the magnetic elements of the sensor.

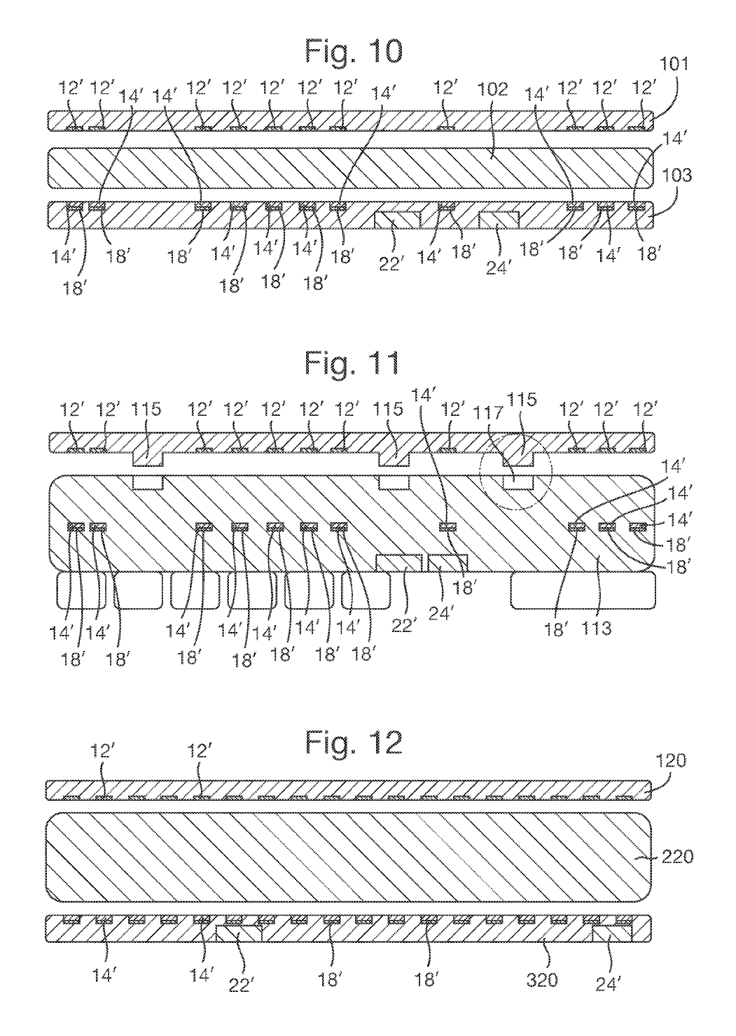

FIG. 10 schematically illustrates how according to a twenty third embodiment of the invention a device, which can be any of those described above, is incorporated into a shoe insole. As illustrated in FIG. 10, the insole comprises three distinct flexible and bendable layers 101, 102, 103 which are three of the conventional layers found in a shoe insole. Typically they may be made of flexible material such as poron, foam, EVA, silicone, silicone gel and/or urethane. In the embodiment of FIG. 10, layer 101 includes a plurality of magnetic field generators 12′ of the same type as the magnetic field generators 12 of the preceding embodiments. The magnetic field generators 12′ can be placed in any configuration to meet the needs of the end-user. FIGS. 13, 14, 15 and 16 illustrate four such configurations based on, respectively, sixteen elements, twenty elements, thirty-one elements and seventy-two elements. The illustrated sensor and magnet placements are effective for monitoring diabetic foot condition and for the majority of foot pathologies, as well as for running, golf and many other sports.

In the insole 100, the second layer 102 is similarly made of a flexible and bendable material such as poron, foam, EVA, silicone, silicone gel and/or urethane and acts as a cushioning layer to provide comfort and support to the user while walking or running. The layer can also comprise air and/or gel for impact absorption. The third layer 103 is also of a flexible and bendable material, using the same materials as listed above, but can also comprise rigid materials such as metal or plastic. The layer 103 incorporates the magnetic field sensor units 14′ which can be an individual magnetic field sensor 14 for each magnetic field generator 12′ (analogous to the embodiments which do not sense shear forces), or each unit 14′ can be an arrangement of plural sensors 14 (analogous to the embodiments above which sense shear forces too), magnetic focussing elements 18′, and the programmable microcontroller and wireless communication unit 22′, optionally the motion sensor 23′ and the power supply unit 24′, which again may be the same as those described above. The electronic devices embedded in layer 103 may be connected and/or placed on a flexible printed circuit board, though as an alternative can be connected by wires embedded in the layer 103. FIGS. 13A, 14A, 15A and 16A illustrate printed circuit board configurations for each of the illustrated sensor configurations. FIGS. 13B, 14B, 15B and 16B illustrate configurations for the layouts of the magnetic field generators 12 for in-shoe embodiments and FIGS. 13C, 14C, 15C and 16C illustrate configurations for the layout of magnetic field generators 12 for on-foot or insole embodiments.

While FIG. 10 illustrates the invention applied to an insole, the invention can also be applied to a shoe as illustrated in the twenty fourth embodiment of FIG. 11. In FIG. 11 the interchangeable insole 110 carries the magnetic field generators 12′ while the sole 113 of the shoe (which is integrated with the shoe upper) carries the magnetic field sensors 14′, magnetic focussing elements 18′, and the microcontroller and wireless communication unit 22′ and power supply unit 24′.

As the magnetic field generators 12′ are relatively cheap, the insole 110 can be regarded as disposable and so is made to be easily interchangeable by not being permanently affixed into the shoe. It is conventional for such insoles to be removable, for example to allow cleaning or drying of the shoe. In order to prevent the insole sliding on the sole, the insole 110 is provided with male surface elements 115 which interlock with female surface elements 117 in the shoe sole. Of course the female elements 117 may be provided on the insole and the male elements 115 on the sole, or some male and female elements may be provided on each. The use of interlocking surface elements is effective in preventing slippage of the insole, but still allows it easily to be removed for cleaning, drying or disposal.

The thickness of the insoles 100 and 110 varies with application, and is typically in the range from 2 mm to 15 mm, more typically around 8 mm.

It will be appreciated that the magnetic field sensors 14′ act to sense changes in the magnetic flux caused by the magnets 12′ moving towards and away from them as pressure is applied to and removed from the upper surface of the insole 100, 110. The magnetic field sensors 14′ generate a varying voltage which is sensed by the microprocessor and wireless communication unit 22′ and transmitted, as with the earlier embodiments, to a remote recording and visualization module 50. By providing the array of devices such as those illustrated in FIGS. 13 to 16, a pattern of the pressure applied through the foot can be obtained and displayed and the changes in pressure with time during typical gait cycles can be recorded and displayed.

As well as providing information about the user, the fact that the magnetic sensors 14′ effectively detect the distance between the sensors 14′ and magnetic field generators 12′ means that they can detect over time any breakdown in the structure of the layers of the insole or shoe (which will be seen as a steady change in the magnetic field sensed by the magnetic field sensors 14′) and thus can monitor the condition and performance of the shoe itself.

It should also be appreciated that although FIG. 11 illustrates that the magnetic field sensors 14′ correspond in number and position to the magnetic field generators 12′, different insoles could be provided with different numbers and arrangement of magnetic field generators 12′. For example fewer magnets could be provided for some applications and more for other applications, all for use with the same shoe. Again the arrangement of magnetic field generators and sensors in the embodiments above may be inverted so that the sensors are uppermost.

FIG. 12 schematically illustrates a cross-section through a twenty fifth embodiment of the invention applied to a product such as a cushion, mattress, seat or saddle. In essence the layout and function are the same as the insole embodiment described above with reference to FIG. 10, except that the layers 120, 220 and 320 are three of the various layers found in the cushion, seat, mattress or saddle. Thus the magnetic field generators 12′ are provided in a higher layer and are spaced from the magnetic field sensors 14′ and magnetic focussing elements 18′ by an intermediate resilient layer 220. Again the microcontroller and wireless communication unit 22′ and power supply unit 24′ are provided in the lower layer 320 connected to the magnetic field sensors 14′ by printed circuit board 140, flexible printed circuit board 140 or embedded wiring. Again the arrangement of magnetic field generators and sensors may be inverted so that the sensors are uppermost. Cushions or mattresses provided with this pressure sensing arrangement can be used to monitor the pressure of the user's body on the cushion or mattress and produce a warning (e.g. visually or audibly) when excessive pressure is detected to avoid ulceration and tissue breakage and damage. The module 50 may also monitor a combination of time and pressure so that individual spikes in pressure can be ignored (e.g. caused by movement), but sustained pressure causes an alert. The sensor arrangement can also be applied to vehicle seats used not only in avoiding fatigue or injuries, but also in monitoring pressure during crash tests and for seat shape optimisation.

In the insole, shoe and mattress/seat/cushion embodiments it is possible to provide only a single sensor to monitor material/object fatigue. For example, the sensor simply monitors the thickness of the sole/mattress/seat/cushion, and provides an indication, e. g. a visual indicator such as illuminating an LED, when the thickness goes below a preset value indicating that replacement of the item is required. This is particularly useful for indicating mattress fatigue or the wearing-out of shoe soles.

In the insole, shoe and mattress/seat/cushion embodiments, the individual force sensing devices may be individually calibrated or the object as a whole may be calibrated by applying known forces and measuring the sensor outputs. As above, in the medical field, or where high accuracy is required, each object and sensor can be individually calibrated and the calibration results stored in the programmable microcontroller or the remote module 50. In health and fitness applications, where lower accuracy is acceptable, but lower cost important, only samples of batches need to be calibrated and the results stored for all objects or sensors of the batch.

FIG. 17 is a block diagram illustrating the various electronic components of the invention. As illustrated the power supply unit 24 or 24′ supplies power to the microcontroller and wireless communication unit 22, 22′ and also to each of the magnetic field sensors 14, 14′, and where provided the motion/orientation sensor 23, 23′ (not illustrated). The outputs of the magnetic field measurements from magnetic field sensors 14, 14′ are fed to the microcontroller and wireless communication unit 22, 22′ (together with motion/orientation where provided). These components are interconnected by printed circuit board 140. The processed measurements are wirelessly transmitted to a remote recording and visualization module 50 which may be embodied in a software application running on a personal computer, tablet or smart phone as mentioned above. The remote recording and visualization module 50 may also return control signals to the wireless communication unit 22, 22′, for example to change settings such as data acquisition rate, number of active sensors, pressure only or shear only operation, self-calibration and zeroing, and to switch the sensors on and off.

A further implementation of the invention is utilising the sensors in accordance with the invention to measure the power applied to a bicycle pedal by the rider's foot.

In any of the above embodiments the individual magnetic field generators 12 can be mechanically linked together by a frame or plate (e.g. disc) e.g. of plastic or other non-magnetic but rigid material. This allows them to form a tilt sensor. FIG. 38 shows this variation of the magnetic element/elements used on layer 1 of the device 10. In this variation, the same number of magnets 12 (in this case three) is used as the number of magnetic sensor elements 14 (e.g. Hall Effect sensors) and the links are schematically illustrated as elongate elements 190 to form a frame. FIGS. 39A and B show the three magnets 12 linked by links 190 positioned over three magnetic sensor elements 14. The magnets 12 are interconnected by the links 190 to create a rigid structure which forces them to act as one object. This enables the device 10 to measure tilt, as well as pressure and shear. If a force is applied on top of one of the magnets 12 in the structure, the side in which this magnet is located will be pushed down, towards the corresponding magnetic sensor element 14, and at the same time (if no force is applied on the other magnets) the other two sides of the magnets frame will be relatively pushed up, away from their corresponding magnetic sensor elements 14. This change in position will be recorded by the magnetic sensor elements 14 and positioning data will be produced, displaying the tilt at the surface of the sensor 10. FIGS. 40A, B and C illustrate a corresponding four magnet/sensor version in which four magnetic field generators 12 are linked by elongate links 190 to form a frame-like single object. Beneath each magnetic field generator 12 is the corresponding magnetic field sensor 14. These particular variations of the device 10 have useful applications in cushions and mattresses where tilt is an important variable. In beds for example tilt can provide data about the user's movements, increasing the accuracy of the pressure and shear measurements and adding information such as body positioning, posture, lying position, pelvic tilt and extension (arching) movement on the lower back, curvature of the body, as well as sleep and position shift (during sleep) monitoring.

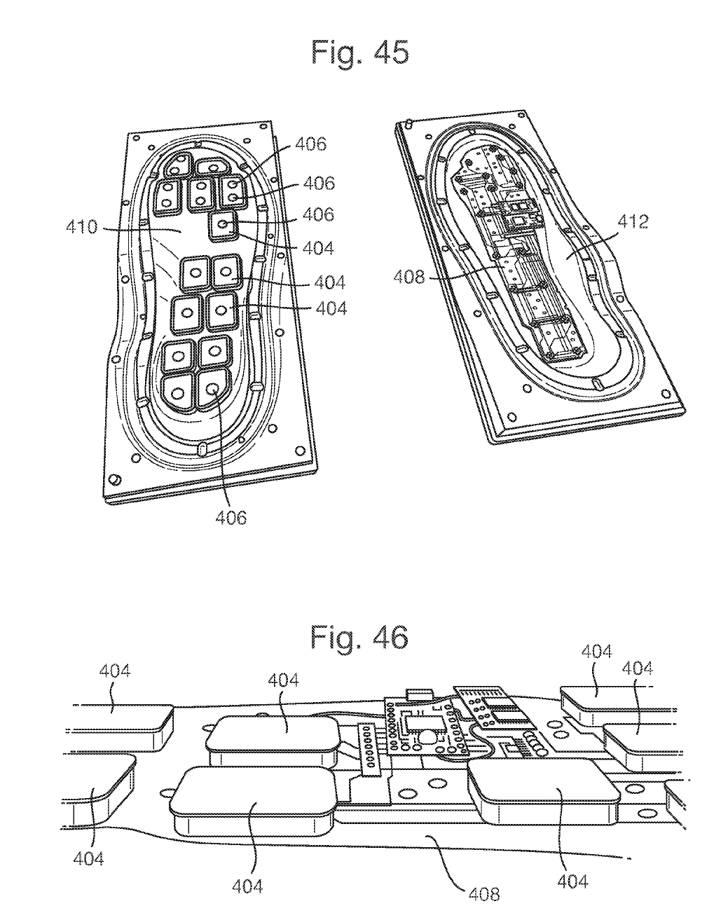

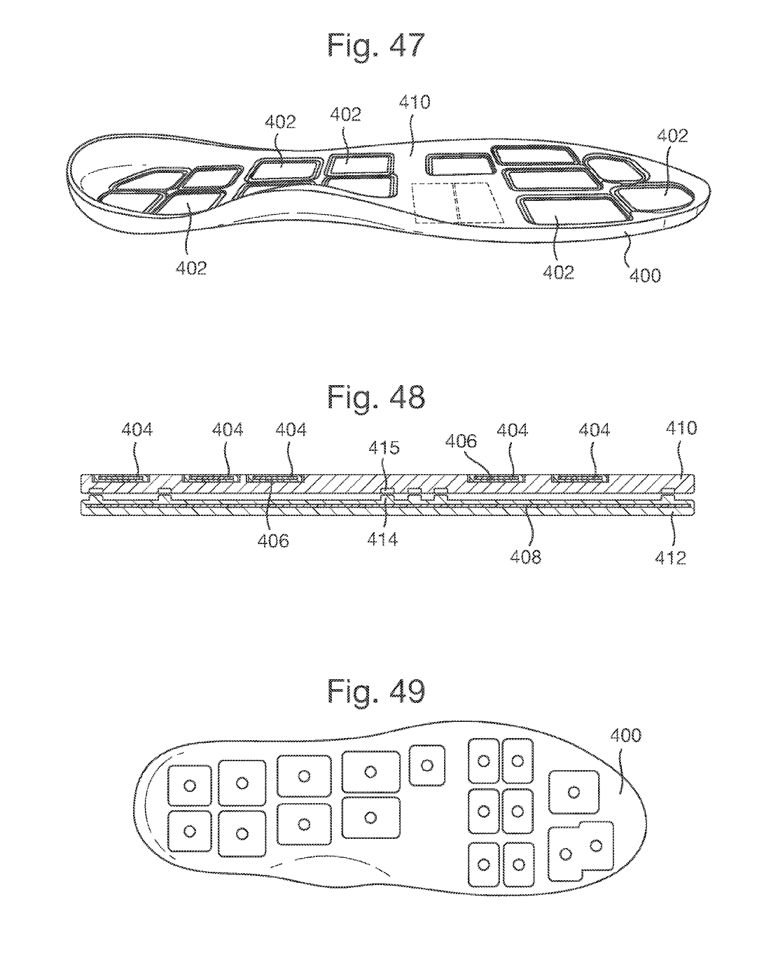

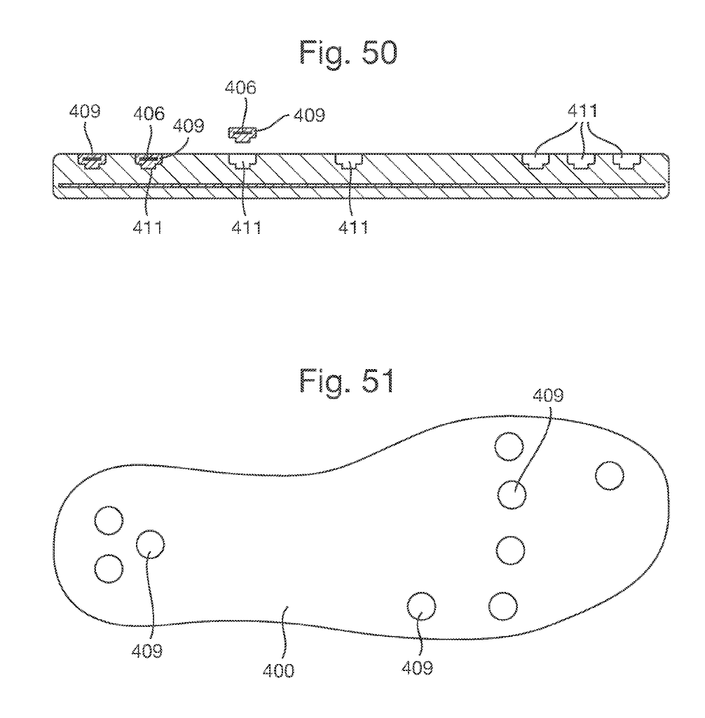

FIGS. 45 to 51 illustrate a smart insole (or in-shoe system) to perform as a multiple force plates system to measure the forces (and their directions) acting between the foot and the insole in the x, y and z directions (F_{X}, F_{y}, F_{z}). As shown in FIGS. 45 and 47 the surface of the insole 400 is divided into distinct areas and a miniature force plate 402 (MFP) (fourteen in this implementation) is positioned in each area. The MFPs are adapted to act autonomously, measuring and recording local Fₓ, F_{y}, and F_{z}, as well as as parts of a “sensor network” with the other MFPs. The miniature force plates 402 are distributed on the surface of the insole 400, in such a way so to provide maximum coverage. The number of the miniature force plates 402 is only limited by the sensor's physical size). Each MFP 402 comprises a top plate 404 which is rigid or semi-rigid and which has one or more permanent magnets 406 attached to its underside—e.g. by glueing, positioned above a magnetic field sensor or array of sensors, which are connected to a flexible printed circuit board (pcb) 408 (though wires may be used as an alternative) which connects them to a power supply (e.g. battery), programmable microcontroller and wireless connection module as with the embodiments above. A magnetic field focussing element may also be included beneath each sensor. The magnets, sensors, focussing elements and ancillary electronic components all preferably are the same as in the embodiments above.

FIGS. 45, 47 and 48 illustrate that the top plate and magnet assemblies are preferably molded in a top layer 410 of the insole 400 and the sensors and pcb are preferably molded in a bottom layer 412, the two layers being molded together or interconnected by male and female inter-engaging shape features 414 ,415.

The miniature in-shoe force plate areas are distinctively marked on top of every insole 400. Each one of these incorporates one top plate 404 and one or two sensing devices (each sensing device consisting of a magnet 406 and magnetic field sensor or array of sensors—e.g. positioned in a square array beneath the magnet as discussed above). More specifically the three miniature force plates at the metatarsal area and the miniature force plate at the big toe area have two sensing devices beneath each top plate, whereas the other MFPs have one sensing device. Due to the shape, characteristics and sensor configuration, each miniature force plate can measure tilt, torque (as relative forces) and the centre of pressure (COP) during gait. The insole unit is shielded to avoid any external interference.

FIG. 49 illustrates an alternative arrangement in which each top plate has only one sensing device beneath it. In this case six MFPs are provided in the metatarsal area and three in the big toe area of the insole.

The insole 400 has Bluetooth capabilities via a wireless connection module, so the only physical connection is a micro charging port, located under the arch area of the insole 400, to recharge the battery. The programmable microcontroller sets the insole's data acquisition rate as well as its resolution. The sensors in the insole have no overload limit. Of cause, if a very high load, e.g above 200N is applied, due to the material properties and thickness used, the sensor will saturate, however, when the load is removed the sensor will go back to zero and it will be functional again. For the sensor to be overloaded and rendered unusable it has to be physically destroyed (the sensor electronics or the intermediate layer above them).

Although illustrated here in a shoe sole, as before the multiple miniature force plates concept is applicable in mattresses, cushions and any application that forces in all three directions need to be measured.

An alternative implementation of the multiple miniature force plates design is shown in FIGS. 51 and 52. In this case the magnets 406 are embedded into small and interchangeable molded silicon “plug” 409 that are fitted into correspondingly-shaped ports or cavities 411 in the surface of the insole 400. The top surface of each plug 409 is flat, providing the top plate of the MFP so that the plug has a mushroom or T-shaped cross-section. Blank plugs without a magnet are also provided so that this design provides the flexibility to use the right number and configuration of “active (with a magnet) plugs”, while filling the rest of the ports 411 with “plugs” not containing a magnet, according to the demands of the user. So for example the same insole can be used by a person with diabetes to monitor six points of high pressure, or by an amateur runner to monitor foot forces during running at fourteen different places.

This miniature force plate implementation of the sensor can also be used to determine surface tilt as well as surface-caused torque. The cross-square configuration of the magnetic field sensors beneath each magnet 406 can detect and measure magnet motion in all 3 orthogonal directions and also twist and rotation around the x and/or y-axis. So the sensor can provide a distance value for tilt which can be translated to a degrees value since we know the physical dimensions of the magnet and/or the surface of the sensor, as well as a torque value, since the force which caused the tilt is measured and the dimensions of the sensor are known.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A shoe comprising a force sensing device comprising a magnetic field generator, a magnetic field sensor, a resilient support supporting the magnetic field generator and magnetic field sensor for relative movement in response to force applied to the device, the magnetic field sensor being disposed to measure changes in the magnetic field from the magnetic field generator resulting from such relative movement, wherein the magnetic field generator is disposed in an insole of the shoe and the magnetic field sensor is disposed in a sole of the shoe over which the insole is disposed, and wherein said resilient support comprises at least one of said insole and sole.

2. A seat, mattress, saddle or cushion incorporating a force sensing device comprising a magnetic field generator, a magnetic field sensor, a resilient support supporting the magnetic field generator and magnetic field sensor for relative movement in response to force applied to the device, the magnetic field sensor being disposed to measure changes in the magnetic field from the magnetic field generator resulting from such relative movement, wherein the magnetic field generator of the device is disposed in a first layer and the magnetic field sensor is disposed in a second layer of the seat, mattress, saddle or cushion.

3. A seat, mattress, saddle or cushion according to claim 2 wherein said resilient support comprises at least one of said first layer, said second layer, an intermediate layer between said first layer and said second layer.

4. A shoe according to claim 1 wherein there are a plurality of magnetic field sensors, the magnetic field sensors being adapted to sense changes in the magnetic field caused by shear forces applied to the force sensing device.

5. A shoe according to claim 1 further comprising a motion sensor for measuring motion of the device.

6. A shoe according to claim 1 wherein the magnetic field sensor is adapted to sense changes in the magnetic field caused by shear forces applied to the force sensing device by comprising one of: a plurality of sensors in an array, an anisotropic magnetoresistance (AMR) sensor, a giant magnetoresistance sensor (GMR).

7. A seat, mattress, saddle or cushion according to claim 2 wherein there are a plurality of magnetic field sensors, the magnetic field sensors being adapted to sense changes in the magnetic field caused by shear forces applied to the force sensing device.

8. A seat, mattress, saddle or cushion according to claim 2 further comprising a motion sensor for measuring motion of the device.

9. A seat, mattress, saddle or cushion according to claim 2 wherein the magnetic field sensor is adapted to sense changes in the magnetic field caused by shear forces applied to the force sensing device by comprising one of: a plurality of sensors in an array, an anisotropic magnetoresistance (AMR) sensor, a giant magnetoresistance sensor (GMR).
